(19) United States
(12) Patent Application Publication
(10) Pub. No.: US 2024/0360333 A1
(43) Pub. Date: Oct. 31, 2024

(54) AQUEOUS DISPERSION, COATING COMPOSITION, COATING FILM AND COATED ARTICLE

(71) Applicant: DAIKIN INDUSTRIES, LTD., Osaka (JP)

(72) Inventors: Eri TANIOKA, Osaka (JP); Katsuhiko IMOTO, Osaka (JP); Shumi YOSHIDA, Osaka (JP); Hisato SANEMASA, Osaka (JP); Megumi SHIBAHARA, Osaka (JP); Susumu WADA, Osaka (JP); Caixia ZHU, Changshu (CN); Kangli YOU, Changshu (CN); Xuan LIU, Changshu (CN); Zhenyu SU, Changshu (CN)

(73) Assignee: DAIKIN INDUSTRIES, LTD., Osaka (JP)

(21) Appl. No.: 18/766,938

(22) Filed: Jul. 9, 2024

Related U.S. Application Data
(63) Continuation of application No. PCT/JP2023/000284, filed on Jan. 10, 2023.

(30) Foreign Application Priority Data
Jan. 10, 2022 (CN) 202210023984.X

(51) Int. Cl. C09D 127/18; C08L 27/18; C08L 29/10; C09D 129/10

(52) U.S. Cl. CPC C09D 127/18; C08L 27/18; C08L 29/10; C09D 129/10; C08L 2201/54

(57) ABSTRACT

The disclosure provides an aqueous dispersion that can provide a film having excellent weather resistance and excellent hardness and that has excellent dispersion stability. The aqueous dispersion contains a fluorine-containing polymer that contains: a polymerized unit (a) based on a fluorine-containing monomer; a polymerized unit (b) based on a carboxy group-containing monomer; and a polymerized unit (c) based on a hydroxy group-containing monomer. The polymerized unit (b) is contained in an amount of 4.0 to 14.0 mol % of all polymerized units and the polymerized unit (c) is contained in an amount of 14.0 to 35.0 mol % of all polymerized units.

### CROSS REFERENCE TO RELATED APPLICATIONS

This application is a Rule 53 (b) Continuation of International Application No. PCT/JP2023/000284 filed Jan. 10, 2023, claiming priority based on Chinese Patent Application No. 202210023984.X filed Jan. 10, 2022, the contents of both of which are incorporated herein by reference in their respective entireties.

### TECHNICAL FIELD

The disclosure relates to aqueous dispersions, coating material compositions, films, and coated articles.

### BACKGROUND ART

Techniques have been known in which an aqueous fluororesin composition is used as a resin for weather-resistant water-based coating material.

Patent Literature documents 1 and 2 each disclose an aqueous coating composition containing a fluorine-containing polymer having a specific structure.

### CITATION LIST

### Patent Literature

Patent Literature 1: JP 2009-046689 A
Patent Literature 2: WO 2008/035779 A1

### SUMMARY

The disclosure relates to an aqueous dispersion containing a fluorine-containing polymer that contains: a polymerized unit (a) based on a fluorine-containing monomer; a polymerized unit (b) based on a carboxy group-containing monomer; and a polymerized unit (c) based on a hydroxy group-containing monomer, the polymerized unit (b) being contained in an amount of 4.0 to 14.0 mol % of all polymerized units and the polymerized unit (c) being contained in an amount of 14.0 to 35.0 mol % of all polymerized units.

### Advantageous Effects

The disclosure can provide an aqueous dispersion that can provide a film having excellent weather resistance and excellent hardness and that has excellent dispersion stability, as well as a coating material composition, a film, and a coated article each containing the aqueous dispersion.

### DESCRIPTION OF EMBODIMENTS

The disclosure will be specifically described below.

The disclosure relates to an aqueous dispersion (hereinafter, also referred to as a first aqueous dispersion) containing a fluorine-containing polymer that contains: a polymerized unit (a) based on a fluorine-containing monomer; a polymerized unit (b) based on a carboxy group-containing monomer; and a polymerized unit (c) based on a hydroxy group-containing monomer, the polymerized unit (b) being contained in an amount of 4.0 to 14.0 mol % of all polymerized units and the polymerized unit (c) being contained in an amount of 14.0 to 35.0 mol % of all polymerized units.

The first aqueous dispersion can provide a film having excellent weather resistance and excellent hardness, as well as a film also having excellent salt water resistance. Thus, the first aqueous dispersion can provide a film having excellent heavy duty performance.

The first aqueous dispersion also has excellent dispersion stability (the fluorine-containing polymer is less likely to precipitate or agglomerate).

The first aqueous dispersion can also provide a film that is excellent in gloss, chemical resistance, alkali resistance, solvent resistance, dirt resistance, and durability.

The fluorine-containing polymer in the first aqueous dispersion contains a polymerized unit (a) based on a fluorine-containing monomer.

Examples of the fluorine-containing monomer include tetrafluoroethylene, chlorotrifluoroethylene, hexafluoropropylene, vinylidene fluoride, vinyl fluoride, trans-1,3,3,3-tetrafluoropropene (HFO-1234ze), 2,3,3,3-tetrafluoropropene (HFO-1234yf), and fluorovinyl ether. One or two or more of these may be used.

To provide a film that is much excellent in hardness, chemical resistance, solvent resistance, corrosion resistance, and weather resistance, the fluorine-containing monomer preferably includes at least one selected from the group consisting of tetrafluoroethylene, chlorotrifluoroethylene, and hexafluoropropylene, more preferably at least one selected from the group consisting of tetrafluoroethylene and chlorotrifluoroethylene.

To provide a film having much excellent weather resistance, the polymerized unit (a) is contained in an amount of preferably 20 to 60 mol % of the fluorine-containing polymer. The amount is more preferably 30 mol % or more, still more preferably 35 mol % or more, while more preferably 55 mol % or less.

Herein, the amounts of the polymerized units of the polymer can be calculated by appropriate combination of NMR, FT-IR, elemental analysis, and X-ray fluorescence analysis in accordance with the types of the monomers.

The fluorine-containing polymer contains a polymerized unit (b) based on a carboxy group-containing monomer.

The carboxy group-containing monomer is preferably one represented by the formula (A):

R^{1a}R^{2a}C═CR^{3a}—(CH₂)ₙ—COOH

wherein R^{1a}, R^{2a}, and R^{3a} are the same as or different from each other, and each represent a hydrogen atom or a C1-C10 linear or branched alkyl group; and n is an integer of 0 or greater. Examples thereof include acrylic acid, methacrylic acid, vinylacetic acid, crotonic acid, pentenoic acid, hexenoic acid, heptenoic acid, octenoic acid, nonenoic acid, decenoic acid, undecylenic acid, dodecenoic acid, tridecenoic acid, tetradecenoic acid, pentadecenoic acid, hexadecenoic acid, heptadecenoic acid, octadecenoic acid, nonadecenoic acid, eicosenoic acid, and 22-tricosenoic acid. To achieve much improvement in weather resistance, hardness, gloss, heavy duty performance, and dispersion stability, preferred among these is at least one selected from the group consisting of acrylic acid, crotonic acid, and undecylenic acid, more preferred is at least one selected from the group consisting of crotonic acid and undecylenic acid, and still more preferred is crotonic acid.

To increase the hardness of a film, crotonic acid is preferably in the form of a trans isomer.

Examples of the carboxy group-containing monomer also include cinnamic acid, 3-allyloxypropionic acid, itaconic acid, itaconic acid monoester, maleic acid, maleic acid monoester, maleic anhydride, fumaric acid, fumaric acid monoester, vinyl phthalate, vinyl pyromellitate, citraconic acid, mesaconic acid, and aconitic acid.

The carboxy group in each polymerized unit (b) contained in the fluorine-containing polymer may be in the form of a salt. Any or all of the carboxy groups may be in the form of a salt; preferably, any of these is in the form of a salt.

Examples of the salt include an ammonium salt, an amine salt, and an alkali metal salt. Preferred among these is an amine salt. Two or more salts may be present.

Examples of the amine include organic amines such as triethylamine, diethylamine, 2-dimethylaminoethanol, ethyl ethanolamine, diethanolamine, monoethanolamine, monopropanolamine, isopropanolamine, ethylaminoethylamine, hydroxyethylamine, diethylenetriamine, and n-butylamine; preferred are triethylamine, diethanolamine, and 2-dimethylaminoethanol, and more preferred are triethylamine and 2-dimethylaminoethanol.

Examples of the alkali metal include sodium hydroxide, potassium hydroxide, calcium hydroxide, sodium hydrogen carbonate, sodium carbonate, potassium carbonate, and calcium carbonate.

In the first aqueous dispersion, the polymerized unit (b) is in an amount of 4.0 to 14.0 mol % of all polymerized units of the fluorine-containing polymer. The polymerized unit (b) in an amount within this range allows the first aqueous dispersion to have excellent dispersion stability.

The amount is more preferably 4.1 mol % or more, still more preferably 4.2 mol % or more, further preferably 4.3 mol % or more, while more preferably 13.0 mol % or less, still more preferably 10.0 mol % or less, further preferably 7.0 mol % or less.

The fluorine-containing polymer preferably has an acid value of 16 mgKOH/g or higher. An acid value within this range can lead to much improved dispersion stability. In general, a higher acid value tends to cause a poorer corrosion resistance of a film. Still, the presence of the aforementioned polymerized unit (b) in the fluorine-containing polymer can lead to a film having improved water vapor permeability. The aqueous dispersion of the disclosure can therefore provide a film having excellent heavy duty performance.

The acid value is more preferably 17 mgKOH/g or higher, still more preferably 20 mgKOH/g or higher, while preferably 70 mgKOH/g or lower, more preferably 65 mgKOH/g or lower, still more preferably 60 mgKOH/g or lower.

The acid value is determined by the neutralization titration in conformity with JIS K5601.

The acid value is a value in the case where the acid group is not in the form of a salt.

The fluorine-containing polymer in the first aqueous dispersion contains a polymerized unit (c) based on a hydroxy group-containing monomer.

The hydroxy group-containing monomer preferably includes at least one selected from the group consisting of hydroxyalkyl vinyl ether, hydroxyalkyl allyl ether, hydroxycarboxylic acid vinyl ester, hydroxycarboxylic acid allyl ester, and hydroxyalkyl (meth)acrylate, more preferably at least one selected from the group consisting of hydroxyalkyl vinyl ether and hydroxyalkyl allyl ether, and is still more preferably hydroxyalkyl vinyl ether.

Examples of the hydroxyalkyl vinyl ether include 2-hydroxyethyl vinyl ether, 3-hydroxypropyl vinyl ether, 2-hydroxypropyl vinyl ether, 2-hydroxy-2-methylpropyl vinyl ether, 4-hydroxybutyl vinyl ether, 4-hydroxy-2-methylbutyl vinyl ether, 5-hydroxypentyl vinyl ether, 6-hydroxyhexyl vinyl ether, and 4-(hydroxymethyl)cyclohexylmethyl vinyl ether.

Examples of the hydroxyalkyl allyl ether include 2-hydroxyethyl allyl ether, 4-hydroxybutyl allyl ether, and glycerol monoallyl ether.

Examples of the hydroxycarboxylic acid vinyl ester include vinyl hydroxyacetate, vinyl hydroxypropanoate, vinyl hydroxybutanoate, vinyl hydroxyhexanoate, and vinyl 4-hydroxycyclohexylacetate.

Examples of the hydroxycarboxylic acid allyl ester include allyl hydroxyacetate, allyl hydroxypropanoate, allyl hydroxybutanoate, allyl hydroxyhexanoate, and allyl 4-hydroxycyclohexylacetate.

Examples of the hydroxyalkyl (meth)acrylate include 2-hydroxyethyl acrylate and 2-hydroxyethyl methacrylate.

In particular, the hydroxy group-containing monomer is preferably one represented by the formula (B):

CH₂═CH—(CH₂)₁—O—(CH₂)ₘ—OH

(wherein 1 is 0 or 1; and m is an integer of 2 to 20), and particularly preferably includes at least one monomer selected from the group consisting of 4-hydroxybutyl vinyl ether, 2-hydroxyethyl vinyl ether, 2-hydroxyethyl allyl ether, and 4-hydroxybutyl allyl ether.

In the first aqueous dispersion, the polymerized unit (c) is contained in an amount of 14.0 to 35.0 mol % of all polymerized units of the fluorine-containing polymer. The polymerized unit (c) in an amount within this range leads to a film much excellent in weather resistance, hardness, gloss, and solvent resistance and allows the aqueous dispersion to have much improved dispersion stability. The amount is more preferably 15.0 mol % or more, still more preferably 19.0 mol % or more, further preferably 22.0 mol % or more, while more preferably 33.0 mol % or less, still more preferably 31.0 mol % or less.

The fluorine-containing polymer in the first aqueous dispersion contains a hydroxy group. This allows the fluorine-containing polymer to be cured (crosslinked), leading to a film much excellent in weather resistance, hardness, and salt water resistance as well as much excellent in heavy duty performance. Further, the aqueous dispersion is allowed to have much improved dispersion stability.

The fluorine-containing polymer in the first aqueous dispersion preferably has a hydroxyl value of 50 to 160 mgKOH/g. This can lead to a film much excellent in weather resistance, hardness, salt water resistance, and solvent resistance as well as much excellent in heavy duty performance, and allows the aqueous dispersion to have much improved dispersion stability.

The hydroxyl value is more preferably 60 mgKOH/g or higher, still more preferably 70 mgKOH/g or higher, further preferably 80 mgKOH/g or higher, particularly preferably 90 mgKOH/g or higher.

The hydroxyl value is determined by calculation from the mass of the fluorine-containing polymer and the number of moles of the —OH group. The number of moles of the —OH group may be determined by NMR analysis, IR measurement, titration, or elementary analysis, for example.

In the case where the actual amount and solid concentration of the hydroxy group monomer during polymerization are known, these values may be used to calculate the hydroxyl value from the mass of the fluorine-containing polymer and the number of moles of the —OH group.

To improve the miscibility, solubility, and adhesiveness, the fluorine-containing polymer preferably further contains a polymerized unit (d) based on a vinyl ester free from a hydroxy group and an aromatic ring or an alkyl vinyl ether free from a hydroxy group. To improve the hardness of a film, the fluorine-containing polymer particularly preferably contains a polymerized unit (d) based on the vinyl ester. The aforementioned carboxy group-containing monomer is commonly less likely to react with a fluorine-containing monomer, but use of the vinyl ester or vinyl ether together can increase the amount of the polymerized unit based on a carboxy group-containing monomer.

The vinyl ester free from a hydroxy group and an aromatic ring is preferably a carboxylic acid vinyl ester, more preferably includes at least one selected from the group consisting of vinyl acetate, vinyl propionate, vinyl butyrate, vinyl isobutyrate, vinyl pivalate, vinyl caproate, vinyl versatate, vinyl laurate, vinyl stearate, and vinyl cyclohexylcarboxylate, still more preferably at least one selected from the group consisting of vinyl acetate, vinyl versatate, vinyl laurate, vinyl stearate, and vinyl cyclohexylcarboxylate, particularly preferably at least one selected from the group consisting of vinyl acetate and vinyl versatate.

To achieve much improved miscibility, solubility, and adhesiveness, the vinyl ester is preferably a carboxylic acid vinyl ester in which the carboxylic acid has a carbon number of 6 or greater, more preferably a carboxylic acid vinyl ester in which the carboxylic acid has a carbon number of 9 or greater. The upper limit of the carbon number of the carboxylic acid in the carboxylic acid vinyl ester is preferably 20, more preferably 15. In terms of antibacterial activity, most preferred are vinyl versatates such as neononanoic acid vinyl ester (Veova9) and neodecanoic acid vinyl ester (Veova10).

Note that the vinyl ester is free from a hydroxy group and an aromatic ring. Preferably, the vinyl ester is also free from a halogen atom.

Examples of the alkyl vinyl ether free from a hydroxy group include methyl vinyl ether, ethyl vinyl ether, n-propyl vinyl ether, isopropyl vinyl ether, n-butyl vinyl ether, isobutyl vinyl ether, tert-butyl vinyl ether, 2-ethylhexyl vinyl ether, cyclohexyl vinyl ether, dodecyl vinyl ether, and octadecyl vinyl ether. Preferred among these is at least one selected from the group consisting of ethyl vinyl ether and cyclohexyl vinyl ether.

The polymerized unit (d) is contained in an amount of preferably 1 to 40 mol % of all polymerized units of the fluorine-containing polymer. The amount is more preferably 10 mol % or more, still more preferably 15 mol % or more, while more preferably 35 mol % or less, still more preferably 30 mol % or less.

The fluorine-containing polymer may further contain a unit (e) based on a monomer different from the aforementioned monomers. For example, the fluorine-containing polymer may contain a polymerized unit based on a monomer such as a carboxylic acid vinyl ester containing an aromatic ring and free from a hydroxy group, an amino group-containing monomer, a hydrolyzable silyl group-containing monomer, or an olefin free from a halogen atom and a hydroxy group. In particular, the polymer preferably contains a polymerized unit based on a carboxylic acid vinyl ester containing an aromatic ring and free from a hydroxy group.

Each of these polymerized units may be contained in an amount of 0 to 15 mol %, preferably 0.1 to 10 mol %, more preferably 0.5 to 8 mol % of all polymerized units of the fluorine-containing polymer.

Examples of the carboxylic acid vinyl ester containing an aromatic ring and free from a hydroxy group include vinyl benzoate and vinyl para-t-butylbenzoate.

Examples of the amino group-containing monomer include an amino vinyl ether represented by CH₂—CH—O—(CH₂)ₓ—NH₂ (x=0 to 10); an amine represented by CH₂—CH—O—CO(CH₂)ₓ—NH₂ (x=1 to 10); and aminomethylstyrene, vinylamine, acrylamide, vinylacetamide, and vinylformamide.

Examples of the hydrolyzable silyl group-containing monomer include (meth)acrylic acid esters such as CH₂═CHCO₂(CH₂)₃Si(OCH₃)₃, CH₂═CHCO₂(CH₂)₃Si(OC₂H₅)₃, CH₂═C(CH₃)CO₂(CH₂)₃Si(OCH₃)₃, CH₂═C(CH₃)CO₂(CH₂)₃Si(OC₂H₅)₃, CH₂═CHCO₂(CH₂)₃SiCH₃(OC₂H₅)₂, CH₂═C(CH₃)CO₂(CH₂)₃SiC₂H₅ (OCH₃)₂, CH₂═C(CH₃)CO₂(CH₂)₃Si(CH₃)₂(OC₂H₅), CH₂═C(CH₃)CO₂(CH₂)₃Si(CH₃)₂OH, CH₂═CH(CH₂)₃Si(OCOCH₃)₃, CH₂═C(CH₃)CO₂(CH₂)₃SiC₂H₅ (OCOCH₃)₂, CH₂═C(CH₃)CO₂(CH₂)₃SiCH₃(N(CH₃)COCH₃)₂/CH₂═CHCO₂ (CH₂)₃SiCH₃[ON(CH₃)C₂H₅]₂, and CH₂═C(CH₃)CO₂(CH₂)₃SiC₆H₅[ON(CH₃)C₂H₅]₂; vinylsilanes such as CH₂═CHSi[ON═C(CH₃)(C₂H₅)]₃, CH₂═CHSi(OCH₃)₃, CH₂═CHSi(OC₂H₅)₃, CH₂═CHSiCH3(OCH₃)₂, CH₂═CHSi(OCOCH₃)₃, CH₂═CHSi(CH₃)₂(OC₂H₅), CH₂═CHSi(CH₃)₂SiCH₃(OCH₃)₂, CH₂═CHSiC₂H₅ (OCOCH₃)₂, CH₂═CHSiCH3 [ON(CH₃)C₂H₅]₂, and vinyltrichlorosilane, and partially hydrolyzed products thereof; and vinyl ethers such as trimethoxysilyl ethyl vinyl ether, triethoxysilyl ethyl vinyl ether, trimethoxysilyl butyl vinyl ether, methyldimethoxysilyl ethyl vinyl ether, trimethoxysilyl propyl vinyl ether, and triethoxysilyl propyl vinyl ether.

Examples of the olefin free from a halogen atom and a hydroxy group include non-fluorine-based olefins such as ethylene, propylene, n-butene, and isobutene.

The fluorine-containing polymer preferably has a number average molecular weight of 3000 to 50000. The number average molecular weight is more preferably 5000 or higher, still more preferably 7000 or higher, while more preferably 40000 or lower, still more preferably 30000 or lower, particularly preferably 20000 or lower. Too low a number average molecular weight may cause poor weather resistance of a film to be obtained and poor stability of the dispersion. Too high a number average molecular weight may cause too high a viscosity when formed into a coating material, causing difficulty in handling.

The number average molecular weight may be determined by gel permeation chromatography (GPC) using tetrahydrofuran as an eluent.

The fluorine-containing polymer preferably has a glass transition temperature (Tg) of 30° C. to 60° C. A Tg within this range can lead to a film having much higher hardness and can lead to a film having much excellent heavy duty performance.

The Tg is more preferably 33° C. or higher, still more preferably 35° C. or higher, while more preferably 50° C. or lower.

The Tg is determined using a differential scanning calorimeter (DSC) (second run).

To achieve improved storage stability, the fluorine-containing polymer preferably satisfies that the proportion of an acid group in the form of a salt is 20 to 90 mol %, more preferably 20 to 80 mol %, still more preferably 20 to 75 mol % of the sum of the acid group in the form of a salt and the acid group not in the form of a salt.

The fluorine-containing polymer can be produced by solution polymerization, emulsion polymerization, suspension polymerization, or bulk polymerization, with one produced by solution polymerization being particularly preferred.

The fluorine-containing polymer is preferably produced by polymerizing monomers to give the above polymerized units through solution polymerization using an organic solvent and a polymerization initiator. The polymerization temperature is commonly 0° C. to 150° C., preferably 5° C. to 95° C. The polymerization pressure is commonly 0.1 to 10 MPaG (1 to 100 kgf/cm²G).

Examples of the organic solvent include esters such as methyl acetate, ethyl acetate, propyl acetate, n-butyl acetate, and tert-butyl acetate; ketones such as acetone, methyl ethyl ketone, and cyclohexanone; aliphatic hydrocarbons such as hexane, cyclohexane, octane, nonane, decane, undecane, dodecane, and mineral spirit; aromatic hydrocarbons such as benzene, toluene, xylene, naphthalene, and solvent naphtha; alcohols such as methanol, ethanol, tert-butanol, iso-propanol, and ethylene glycol monoalkyl ether; cyclic ethers such as tetrahydrofuran, tetrahydropyran, and dioxane; dimethyl sulfoxide; and mixtures thereof.

Examples of the polymerization initiator include persulfates such as ammonium persulfate and potassium persulfate (optionally in combination with any of reducing agents such as sodium hydrogen sulfite, sodium pyrosulfite, cobalt naphthenate, and dimethyl aniline); redox initiators each of which is a combination of an oxidizing agent (e.g., ammonium peroxide or potassium peroxide), a reducing agent (e.g., sodium sulfite), and a transition metal salt (e.g., iron sulfate); diacyl peroxides such as acetyl peroxide and benzoyl peroxide; dialkoxycarbonyl peroxides such as isopropoxycarbonyl peroxide and tert-butoxycarbonyl peroxide; ketone peroxides such as methyl ethyl ketone peroxide and cyclohexanone peroxide; hydroperoxides such as hydrogen peroxide, tert-butyl hydroperoxide, and cumene hydroperoxide; dialkyl peroxides such as di-tert-butyl peroxide and dicumyl peroxide; alkyl peroxy esters such as tert-butyl peroxyacetate and tert-butyl peroxypivalate; and azo compounds such as 2,2′-azobisisobutyronitrile, 2,2′-azobis(2,4-dimethylvaleronitrile), 2,2′-azobis(2-methylvaleronitrile), 2,2′-azobis(2-cyclopropylpropionitrile), dimethyl 2,2′-azobisisobutyrate, 2,2′-azobis[2-(hydroxymethyl) propionitrile], and 4,4′-azobis(4-cyanopentenoic acid).

If necessary, an alcohol such as methanol, ethanol, or propanol may be used as a molecular weight modifier.

The aqueous dispersion of the disclosure may contain water. The fluorine-containing polymer may be dispersed in water.

The aqueous dispersion of the disclosure can be prepared by feeding a polymerization reaction solution of the fluorine-containing polymer into water with stirring or by adding water to the polymerization reaction solution with stirring.

The fluorine-containing polymer, when containing an acid group such as a carboxy group not in the form of a salt, may be subjected to neutralization treatment before mixing, during mixing, or after mixing with water.

Examples of a neutralizer used for neutralization include ammonia; organic amines such as triethylamine, diethylamine, ethyl ethanolamine, diethanolamine, monoethanolamine, monopropanolamine, isopropanolamine, ethylaminoethylamine, hydroxyethylamine, diethylenetriamine, 2-dimethylaminoethanol, and n-butylamine; and alkali metal hydroxides such as sodium hydroxide and potassium hydroxide. In terms of easy availability and emulsion stability, for example, preferred among these are triethylamine, 2-dimethylaminoethanol, and diethanolamine; in terms of easy handleability, particularly preferred are triethylamine and 2-dimethylaminoethanol.

The neutralizer is preferably used in the form of an aqueous solution, and may be used in the form of gas or solid.

The neutralization resultantly converts the acid group into an ammonium salt, an amine salt, or an alkali metal salt.

The neutralization is preferably such that the amount of the acid to be neutralized is 1 mol % or more. The amount of the acid to be neutralized is more preferably 1.5 mol % or more, still more preferably 2 mol % or more, further preferably 2.3 mol % or more. The amount of the acid to be neutralized may be 14 mol % or less, and is preferably 7 mol % or less, more preferably 4.5 mol % or less.

The amount of the acid to be neutralized refers to the proportion of the polymerized unit containing the acid to be neutralized relative to all polymerized units.

To achieve good coating efficiency, the first aqueous dispersion has a solids concentration of preferably 20% by mass or higher, more preferably 30% by mass or higher. In terms of emulsion stability, the solids concentration is preferably 70% by mass or lower, more preferably 60% by mass or lower.

To improve the stability of the aqueous dispersion, a surfactant may be further added. A surfactant preferably used may be an anion surfactant, a nonionic surfactant, or combination of these. In some cases, an amphoteric surfactant or a cationic surfactant may be used.

To achieve much improved dispersion stability, the surfactant is preferably a surfactant containing a polycyclic hydrocarbon group, more preferably an anion surfactant containing a polycyclic hydrocarbon group or a nonionic surfactant containing a polycyclic hydrocarbon group.

To achieve much improved dispersion stability, the surfactant is preferably a compound represented by the following formula (X1):

(A¹-L-)ₘA²X

wherein A¹ is a monovalent hydrocarbon ring group; L is a single bond or a divalent hydrocarbon group; m is an integer of 1 to 5; A² is a hydrocarbon ring group having a valence of m+1; and X is a hydrophilic group.

The hydrocarbon ring group for A¹ may contain a substituent. The hydrocarbon ring group has a carbon number of preferably 6 to 20, more preferably 6 to 10.

The hydrocarbon ring group is preferably an aromatic hydrocarbon group obtainable by removing one hydrogen atom from an aromatic hydrocarbon such as benzene, naphthalene, or anthracene, more preferably a phenyl group.

The hydrocarbon ring group for A² may contain a substituent. The hydrocarbon ring group has a carbon number of preferably 6 to 20, more preferably 6 to 10.

The hydrocarbon ring group is preferably an aromatic hydrocarbon group obtainable by removing m+1 hydrogen atoms from an aromatic hydrocarbon such as benzene, naphthalene, or anthracene, more preferably a group obtainable by removing m+1 hydrogen atoms from benzene.

The hydrocarbon group for L has a carbon number of preferably 1 to 10, more preferably 1 to 5, still more preferably 1 to 3, particularly preferably 1 or 2. The hydrocarbon group is preferably an alkylene group having the above carbon number, more preferably a group represented by —CHCH₃— or —CH₂—.

In the formula, m is an integer of 1 to 5, preferably an integer of 1 to 4, more preferably an integer of 1 to 3.

Examples of the hydrophilic group for X include anionic groups such as —COOM, —SO₂M, —SO₃M, —PO₃M₂, and —OSO₃M, wherein M is H, a metal atom, NR^{x1}₄, imidazolium optionally containing a substituent, pyridinium optionally containing a substituent, or phosphonium optionally containing a substituent, where R^{x1} is H or an organic group; and groups represented by —O(R^{x}O)ₙY, wherein R^{x} is an alkylene group; n is an integer of 1 to 100; and Y is H or an anionic group.

Examples of the metal atom include alkali metals (Group 1) and alkaline earth metals (Group 2), such as Na, K, and Li.

R^{x1} may be H or a C1-C10 organic group, H or a C1-C4 organic group, or H or a C1-C4 alkyl group.

Examples of the anionic group for Y include-COOM, —SO₂M, and —SO₃M, wherein M is as defined above.

The alkylene group for R^{x} is preferably a C2-C5 alkylene group, more preferably an ethylene group or a propylene group, still more preferably an ethylene group.

In the formula, n is an integer of 1 to 100, preferably an integer of 1 to 50, more preferably an integer of 3 to 40.

To achieve much improved dispersion stability, the surfactant is particularly preferably a compound represented by the following formula (X2):

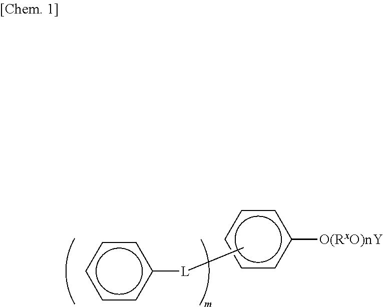

wherein L, m, R^{x}, n, and Y are as defined above.

Preferred L, m, R^{x}, n, and Y are as described above.

The surfactant used may be any of the following items.

The anion surfactant used may be a sodium salt of a sulfuric acid ester of a higher alcohol, sodium alkylbenzene sulfonate, a sodium salt of dialkyl succinate sulfonic acid, or a sodium salt of an alkyl diphenyl ether sulfonic acid, for example. Preferred specific examples among these include a sodium alkylbenzene sulfonate, sodium lauryl sulfate, and polyoxyethylene alkyl (or alkylphenyl) ether sulfonate. The nonionic surfactant used may be, for example, a polyoxyethylene alkyl ether or a polyoxyethylene alkyl aryl ether. Preferred specific examples thereof include polyoxyethylene nonyl phenyl ether and polyoxyethylene octyl phenyl ether. A preferred example of the amphoteric surfactant is lauryl betaine. The cationic surfactant used may be, for example, an alkyl pyridinium chloride and an alkyl ammonium chloride. A surfactant copolymerizable with a monomer to form the fluorine-containing polymer, such as sodium styrene sulfonate or sodium alkyl aryl sulfonate, may also be used.

Commercially available products of an anion surfactant represented by the formula (X2) (wherein Y is an anionic group) include HITENOL NF-08 (available from DKS Co., Ltd.), HITENOL NF-0825 (available from DKS Co., Ltd.), HITENOL NF-13 (available from DKS Co., Ltd.), HITENOL NF-17 (available from DKS Co., Ltd.), LATEMUL E-1000A (available from Kao Corp.), and Newcol 707SF (Nippon Nyukazai Co., Ltd.).

Commercially available products of a nonionic surfactant represented by the formula (X2) (wherein Y is H) include NOIGEN EA-017 (available from DKS Co., Ltd.), NOIGEN EA-87 (available from DKS Co., Ltd.), NOIGEN EA-137 (available from DKS Co., Ltd.), NOIGEN EA-157 (available from DKS Co., Ltd.), NOIGEN EA-167 (available from DKS Co., Ltd.), NOIGEN EA-177 (available from DKS Co., Ltd.), NOIGEN EA-197D (available from DKS Co., Ltd.), NOIGEN EA-207D (available from DKS Co., Ltd.), EMULGEN A-60 (available from Kao Corp.), EMULGEN A-90 (available from Kao Corp.), EMULGEN A-500 (available from Kao Corp.), EMULGEN B-66 (available from Kao Corp.), and Newcol 707 (Nippon Nyukazai Co., Ltd.).

The first aqueous dispersion contains the surfactant in an amount of preferably 10.0% by mass or less, more preferably 7.0% by mass or less, still more preferably 5.0% by mass or less relative to the fluorine-containing polymer. The amount may be 0.001% by mass or more, and is preferably 0.01% by mass or more, more preferably 0.1% by mass or more, and may be 1.0% by mass or more.

The first aqueous dispersion may be free from a surfactant.

The first aqueous dispersion contains the anion surfactant in an amount of preferably 10.0% by mass or less, more preferably 7.0% by mass or less, still more preferably 5.0% by mass or less relative to the fluorine-containing polymer. The amount may be 0.001% by mass or more, and is preferably 0.01% by mass or more, more preferably 0.1% by mass or more, and may be 1.0% by mass or more.

The first aqueous dispersion may be free from an anion surfactant.

The first aqueous dispersion contains the nonionic surfactant in an amount of preferably 10.0% by mass or less, more preferably 7.0% by mass or less, still more preferably 5.0% by mass or less relative to the fluorine-containing polymer. The amount may be 0.001% by mass or more, and is preferably 0.01% by mass or more, more preferably 0.1% by mass or more, and may be 1.0% by mass or more.

The first aqueous dispersion may be free from a nonionic surfactant.

Particles of the fluorine-containing polymer in the first aqueous dispersion have an average particle size of preferably 50 nm or greater, more preferably 70 nm or greater, while preferably 300 nm or smaller, more preferably 250 nm or smaller.

The average particle size is determined by dynamic light scattering.

The first aqueous dispersion may be free from an organic solvent or may contain a small amount of an organic solvent.

In the case where an organic solvent is contained, the amount thereof is preferably 2.0% by mass or less, more preferably 1.0% by mass or less of the aqueous dispersion. The amount may be 0.01% by mass or more.

In particular, each amount of n-butyl acetate and ethanol preferably falls within the above range.

Examples of the organic solvent include esters such as ethyl acetate, n-butyl acetate, tert-butyl acetate, isopropyl acetate, isobutyl acetate, cellosolve acetate, and propylene glycol methyl ether acetate; ketones such as acetone, methyl ethyl ketone, methyl isobutyl ketone, and cyclohexanone; cyclic ethers such as tetrahydrofuran and dioxane; amides such as N, N-dimethyl formamide and N, N-dimethyl acetamide; aromatic hydrocarbons such as toluene and xylene; alcohols such as propylene glycol methyl ether; hydrocarbons such as hexane and heptane; and solvent mixtures thereof. Examples thereof also include the third-class organic solvents mentioned in the Industrial Safety and Health Act and solvents equivalent thereto, which are called weak solvents.

The organic solvent may be the organic solvent used in polymerization production of the fluorine-containing polymer.

In the case where the aqueous dispersion of the disclosure is obtained from a liquid mixture of a solution-polymerized liquid of the fluorine-containing polymer and water, the amount of the organic solvent can be adjusted to fall within the above range by removing the organic solvent by distillation or vacuum distillation. For example, in preparation of the aqueous dispersion, the organic solvent used for solution polymerization may be removed by heating. In order to save the energy cost and in consideration of cases where thermally unstable functional groups or copolymerized units are present, the heating is preferably performed at the lowest possible temperature. The heating temperature is preferably 100° C. or lower, more preferably 70° C. or lower, while preferably 20° C. or higher, more preferably 30° C. or higher.

The disclosure also relates to an aqueous dispersion (hereinafter, also referred to as a second aqueous dispersion) containing: a fluorine-containing polymer that contains a polymerized unit (a) based on a fluorine-containing monomer and a polymerized unit (b) based on a carboxy group-containing monomer; and a surfactant.

The second aqueous dispersion can provide a film having excellent weather resistance and excellent hardness, as well as a film also having excellent salt water resistance. Thus, the second aqueous dispersion can provide a film having excellent heavy duty performance.

The second aqueous dispersion also has excellent dispersion stability (the fluorine-containing polymer is less likely to precipitate or agglomerate).

The second aqueous dispersion can also provide a film that is excellent in gloss, chemical resistance, alkali resistance, solvent resistance, dirt resistance, and durability.

The fluorine-containing polymer in the second aqueous dispersion contains a polymerized unit (a) based on a fluorine-containing monomer. Preferred fluorine-containing monomers and preferred amounts of the polymerized unit (a) are the same as those described for the first aqueous dispersion.

The fluorine-containing polymer in the second aqueous dispersion contains a polymerized unit (b) based on a carboxy group-containing monomer. Preferred carboxy group-containing monomers are the same as those described for the first aqueous dispersion.

To achieve much improved dispersion stability, the polymerized unit (b) in the second aqueous dispersion may be in an amount of 2.0 mol % or more, preferably 3.0 mol % or more, more preferably 3.5 mol % or more, still more preferably 4.0 mol % or more, further preferably 4.1 mol % or more, particularly preferably 4.2 mol % or more, most preferably 4.3 mol % or more, while it may be in an amount of 20.0 mol % or less, preferably 15.0 mol % or less, more preferably 14.0 mol % or less, still more preferably 13.0 mol % or less, further preferably 10.0 mol % or less, particularly preferably 7.0 mol % or less.

The fluorine-containing polymer in the second aqueous dispersion preferably contains a polymerized unit (c) based on a hydroxy group-containing monomer. Preferred hydroxy group-containing monomers are the same as those described for the first aqueous dispersion.

To achieve much improvement in weather resistance, hardness, gloss, dispersion stability, and solvent resistance, the second aqueous dispersion contains the polymerized unit (c) in an amount of preferably 5.0 mol % or more, more preferably 7.0 mol % or more, still more preferably 10.0 mol % or more, further preferably 14.0 mol % or more, furthermore preferably 15.0 mol % or more, particularly preferably 19.0 mol % or more, most preferably 22.0 mol % or more, while preferably 40.0 mol % or less, more preferably 35.0 mol % or less, still more preferably 33.0 mol % or less, further preferably 31.0 mol % or less of all polymerized units of the fluorine-containing polymer.

The other features of the fluorine-containing polymer in the second aqueous dispersion can be the same as those of the fluorine-containing polymer in the first aqueous dispersion.

The second aqueous dispersion contains a surfactant. This allows the second aqueous dispersion to have excellent dispersion stability. Preferred surfactants and preferred amounts thereof are the same as those described for the first aqueous dispersion.

The other features of the second aqueous dispersion can be the same as those of the first aqueous dispersion.

The first and second aqueous dispersions can be suitably used for a coating material, particularly a water-based coating material.

The disclosure also relates to a coating material composition containing the aforementioned aqueous dispersion of the disclosure.

The coating material composition of the disclosure is preferably a water-based coating material.

The coating material composition of the disclosure preferably further contains a curing agent. This allows the coating material composition to form a cured film. In the case of containing a curing agent, the coating material composition can be used as a room temperature-curable coating material, which is curable at room temperature. The coating material composition can also be used as a heat-curable coating material.

The curing agent used may be a compound crosslinkable by a reaction with a curable functional group (e.g., a hydroxy group or a carboxy group) of the fluorine-containing polymer. Examples of the curing agent used include an isocyanate, an amino resin, an acid anhydride, a polyepoxy compound, an isocyanate group-containing silane compound, a carbodiimide, an oxazoline, and an aziridine. Preferred among these are an isocyanate, a carbodiimide, and an oxazoline, and more preferred is a polyisocyanate compound.

Specific examples of the amino resin include, but are not limited to, urea resin, melamine resin, benzoguanamine resin, glycoluril resin, methylolated melamine resin produced by methylolating melamine, and alkyl-etherified melamine resin produced by etherifying methylolated melamine with an alcohol such as methanol, ethanol, or butanol.

Specific examples of the acid anhydride include, but are not limited to, phthalic anhydride, pyromellitic anhydride, and mellitic anhydride.

Examples of the polyepoxy compound and the isocyanate group-containing silane compound used include those disclosed in JP H02-232250 A and JP H02-232251 A. Preferred examples thereof include the following.

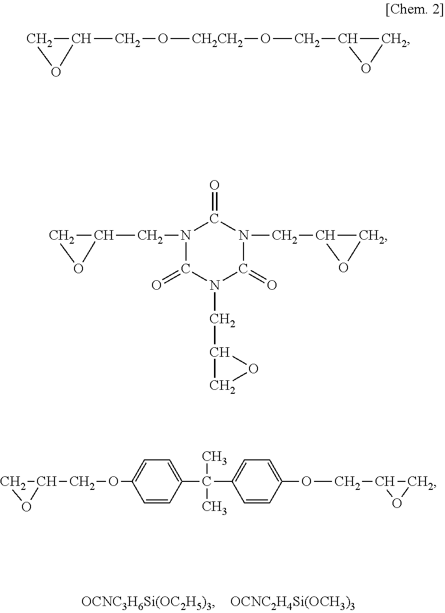

The polyisocyanate compound preferably includes at least one compound selected from the group consisting of a polyisocyanate compound derived from at least one isocyanate selected from the group consisting of xylylene diisocyanate (XDI) and bis(isocyanatomethyl)cyclohexane (hydrogenated XDI, H6XDI), a blocked isocyanate compound based on hexamethylene diisocyanate (HDI), a polyisocyanate compound derived from hexamethylene diisocyanate (HDI), a polyisocyanate compound derived from isophorone diisocyanate (IPDI), and a water-dispersible polyisocyanate compound.

In the case where the polyisocyanate compound used is a polyisocyanate compound (hereinafter, also referred to as a polyisocyanate compound (I)) derived from at least one isocyanate (hereinafter, also referred to as an isocyanate (i)) selected from the group consisting of xylylene diisocyanate (XDI) and bis(isocyanatomethyl)cyclohexane (hydrogenated XDI, H6XDI), the compound can lead to much excellent adhesiveness.

Examples of the polyisocyanate compound (I) include an adduct obtainable by addition polymerization of the isocyanate (i) and an aliphatic polyhydric alcohol having three or more hydroxy groups, an isocyanurate structure (nurate structure) including the isocyanate (i), and a biuret of the isocyanate (i).

The adduct is preferably one having a structure represented by the following formula (1):

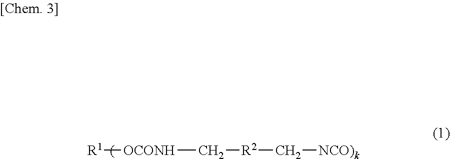

wherein R¹ is a C3-C20 aliphatic hydrocarbon group; R² is a phenylene group or a cyclohexylene group; and k is an integer of 3 to 20.

R¹ in the formula (1) is a hydrocarbon group based on the aliphatic polyhydric alcohol having three or more hydroxy groups, and is preferably a C3-C10 aliphatic hydrocarbon group, more preferably a C3-C6 aliphatic hydrocarbon group.

In the case of a phenylene group, R² may be any of a 1,2-phenylene group (o-phenylene group), a 1,3-phenylene group (m-phenylene group), and a 1,4-phenylene group (p-phenylene group). Preferred among these is a 1,3-phenylene group (m-phenylene group). Every R² in the formula (1) may be the same phenylene group, or two or more different phenylene groups may coexist with each other.

In the case of a cyclohexylene group, R² may be any of a 1,2-cyclohexylene group, a 1,3-cyclohexylene group, and a 1,4-cyclohexylene group. Preferred among these is a 1,3-cyclohexylene group. Every R² in the formula (1) may be the same cyclohexylene group, or two or more different cyclohexylene groups may coexist with each other.

The symbol k refers to the number of hydroxy groups in the aliphatic polyhydric alcohol having three or more hydroxy groups. The symbol k is more preferably an integer of 3 to 10, still more preferably an integer of 3 to 6.

The isocyanurate structure is one having one or two or more isocyanurate rings represented by the following formula (2):

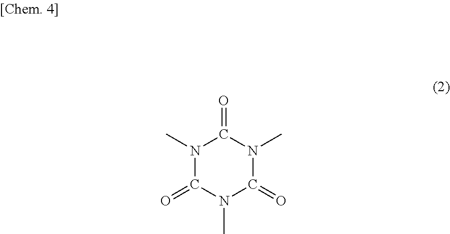

in the molecule.

Examples of the isocyanurate structure include a trimer obtainable by trimerization of the isocyanate, a pentamer obtainable by pentamerization thereof, and a heptamer obtainable by heptamerization thereof.

Preferred among these is a trimer represented by the following formula (3):

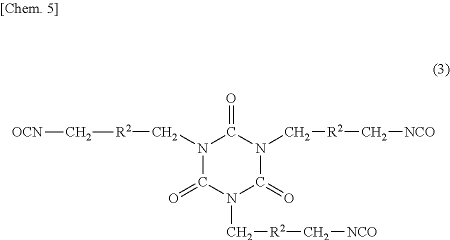

wherein R² is defined as described for R² in the formula (1). In other words, the isocyanurate structure is preferably a trimer of at least one isocyanate selected from the group consisting of xylylene diisocyanate and bis(isocyanatomethyl)cyclohexane.

The biuret is a compound having a structure represented by the following formula (4):

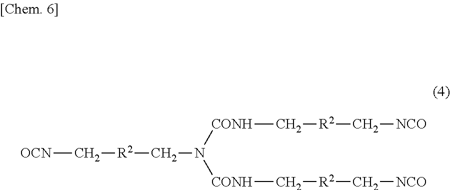

(wherein R² is defined as described for R² in the formula (1)) and is obtainable by trimerization of the isocyanate under the conditions different from those for producing the isocyanurate structure.

In particular, the polyisocyanate compound (I) is preferably the adduct, i.e., one obtainable by addition polymerization of at least one isocyanate selected from the group consisting of xylylene diisocyanate and bis(isocyanatomethyl) cyclohexane and an aliphatic polyhydric alcohol having three or more hydroxy groups.

In the case where the polyisocyanate compound (I) is an adduct of the isocyanate (i) and an aliphatic polyhydric alcohol having three or more hydroxy groups, specific examples of this aliphatic polyhydric alcohol having three or more hydroxy groups include trihydric alcohols such as glycerol, trimethylolpropane (TMP), 1,2,6-hexanetriol, trimethylolethane, 2,4-dihydroxy-3-hydroxymethylpentane, 1,1,1-tris(bishydroxymethyl) propane, and 2,2-bis(hydroxymethyl) butanol-3; tetrahydric alcohols such as pentaerythritol and diglycerol; pentahydric alcohols (pentits) such as arabit, ribitol, and xylitol; and hexahydric alcohols (hexits) such as sorbit, mannit, galactitol, and allodulcit. Particularly preferred among these are trimethylolpropane and pentaerythritol.

Examples of the xylylene diisocyanate (XDI) used as a structural component of the adduct include 1,3-xylylene diisocyanate (m-xylylene diisocyanate), 1,2-xylylene diisocyanate (o-xylylene diisocyanate), and 1,4-xylylene diisocyanate (p-xylylene diisocyanate); preferred among these is 1,3-xylylene diisocyanate (m-xylylene diisocyanate).

Examples of the bis(isocyanatomethyl) cyclohexane (hydrogenated XDI, H6XDI) used as a structural component of the adduct include 1,3-bis(isocyanatomethyl) cyclohexane, 1,2-bis(isocyanatomethyl) cyclohexane, and 1,4-bis(isocyanatomethyl) cyclohexane; preferred among these is 1,3-bis(isocyanatomethyl) cyclohexane.

Addition polymerization of at least one isocyanate selected from the group consisting of xylylene diisocyanate and bis(isocyanatomethyl) cyclohexane and the aforementioned aliphatic polyhydric alcohol having three or more hydroxy groups can provide an adduct.

A specific example of the adduct is a compound represented by the following formula (5):

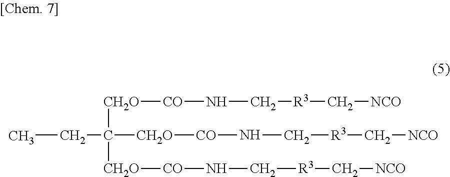

(wherein R³ is a phenylene group or a cyclohexylene group), i.e., a polyisocyanate compound obtainable by addition polymerization of at least one isocyanate selected from the group consisting of xylylene diisocyanate and bis(isocyanatomethyl) cyclohexane and trimethylol propane (TMP).

The phenylene group or cyclohexylene group represented by R³ in the formula (5) is as described for R² in the formula (1).

Commercially available products of the polyisocyanate compound represented by the formula (5) include Takenate D110N (available from Mitsui Chemicals, Inc., adduct of XDI and TMP, NCO content 11.8%) and Takenate D120N (available from Mitsui Chemicals, Inc., adduct of H6XDI and TMP, NCO content 11.0%).

Specific examples of the polyisocyanate compound (I) in the form of an isocyanurate structure include Takenate D121N (available from Mitsui Chemicals, Inc., H6XDI nurate, NCO content 14.0%) and Takenate D127N (available from Mitsui Chemicals, Inc., H6XDI nurate, H6XDI trimer, NCO content 13.5%).

In the case where the polyisocyanate compound used is a blocked isocyanate based on hexamethylene diisocyanate (HDI) (hereinafter, also referred to simply as a blocked isocyanate), the antibacterial coating material is allowed to have a sufficient pot life (usable time).

The blocked isocyanate is preferably one obtainable by reacting a polyisocyanate compound derived from hexamethylene diisocyanate (hereinafter, also referred to as a polyisocyanate compound (II)) with a blocking agent.

Examples of the polyisocyanate compound (II) include an adduct obtainable by addition polymerization of hexamethylene diisocyanate and an aliphatic polyhydric alcohol having three or more hydroxy groups, an isocyanurate structure (nurate structure) including hexamethylene diisocyanate, and a biuret of hexamethylene diisocyanate.

The adduct is preferably one having a structure represented by the following formula (6):

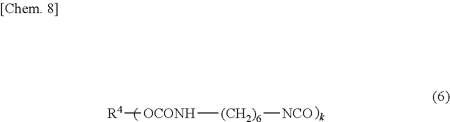

wherein R⁴ is a C3-C20 aliphatic hydrocarbon group; and k is an integer of 3 to 20.

R⁴ in the formula (6) is a hydrocarbon group based on the aliphatic polyhydric alcohol having three or more hydroxy groups, and is preferably a C3-C10 aliphatic hydrocarbon group, more preferably a C3-C6 aliphatic hydrocarbon group. The symbol k refers to the number of hydroxy groups in the aliphatic polyhydric alcohol having three or more hydroxy groups. The symbol k is more preferably an integer of 3 to 10, still more preferably an integer of 3 to 6.

The isocyanurate structure is one having one or two or more isocyanurate rings represented by the following formula (2):

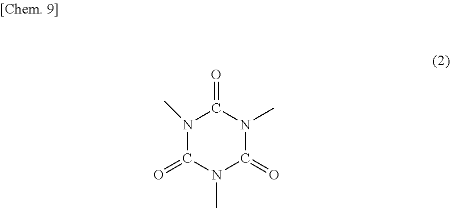

in the molecule.

Examples of the isocyanurate structure include a trimer obtainable by trimerization of the isocyanate, a pentamer obtainable by pentamerization thereof, and a heptamer obtainable by heptamerization thereof.

In particular, a trimer represented by the following formula (7):

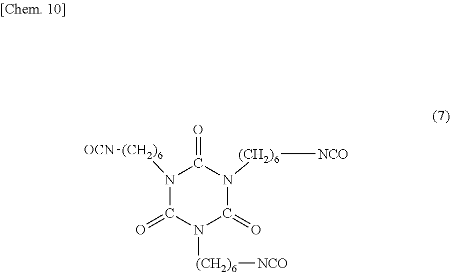

is preferred.

The biuret is a compound having a structure represented by the following formula (8):

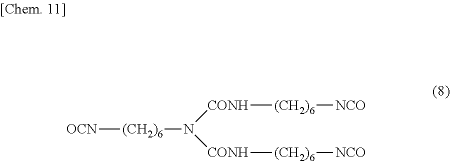

and is obtainable by trimerization of hexamethylene diisocyanate under the conditions different from those for producing the isocyanurate structure.

The blocking agent used is preferably a compound containing active hydrogen. The compound having active hydrogen used preferably includes at least one selected from the group consisting of an alcohol, an oxime, a lactam, an active methylene compound, and a pyrazole compound.

As described above, preferably, the blocked isocyanate is one obtainable by reacting a polyisocyanate compound derived from hexamethylene diisocyanate with a blocking agent and the blocking agent includes at least one selected from the group consisting of an alcohol, an oxime, a lactam, an active methylene compound, and a pyrazole compound.

In the case where the polyisocyanate compound (II) for producing a blocked isocyanate is an adduct of hexamethylene diisocyanate and an aliphatic polyhydric alcohol having three or more hydroxy groups, specific examples of this aliphatic polyhydric alcohol having three or more hydroxy groups include trihydric alcohols such as glycerol, trimethylolpropane (TMP), 1,2,6-hexanetriol, trimethylolethane, 2,4-dihydroxy-3-hydroxymethylpentane, 1,1,1-tris(bishydroxymethyl) propane, and 2,2-bis(hydroxymethyl) butanol-3; tetrahydric alcohols such as pentaerythritol and diglycerol; pentahydric alcohols (pentits) such as arabit, ribitol, and xylitol; and hexahydric alcohols (hexits) such as sorbit, mannit, galactitol, and allodulcit. Particularly preferred among these are trimethylolpropane and pentaerythritol.

Addition polymerization of hexamethylene diisocyanate and the aforementioned aliphatic polyhydric alcohol having three or more hydroxy groups can provide the adduct.

Specific examples of the compound having an active hydrogen to be reacted with the polyisocyanate compound (II) include alcohols such as methanol, ethanol, n-propanol, isopropanol, and methoxy propanol; oximes such as acetone oxime, 2-butanone oxime, and cyclohexanone oxime; lactams such as ε-caprolactam; active methylene compounds such as methyl acetoacetate and ethyl malonate; and pyrazole compounds such as 3-methylpyrazole, 3,5-dimethylpyrazole, and 3,5-diethylpyrazole. One or two or more of these may be used. Preferred among these are active methylene compounds and oximes, with active methylene compounds being more preferred.

Commercially available products of the blocked isocyanate include Duranate K6000 (available from Asahi Kasei Chemicals Corp., HDI-derived blocked isocyanate with active methylene compound), Duranate TPA-B80E (available from Asahi Kasei Chemicals Corp.), Duranate MF-B60X (available from Asahi Kasei Chemicals Corp.), Duranate 17B-60PX (available from Asahi Kasei Chemicals Corp.), Coronate 2507 (available from Nippon Polyurethane Industry Co., Ltd.), Coronate 2513 (available from Nippon Polyurethane Industry Co., Ltd.), Coronate 2515 (available from Nippon Polyurethane Industry Co., Ltd.), Sumidur BL-3175 (available from Sumika Bayer Urethane Co., Ltd.), Luxate HC1170 (available from Olin Chemicals), and Luxate HC2170 (available from Olin Chemicals).

The polyisocyanate compound used may be a polyisocyanate compound derived from hexamethylene diisocyanate (HDI) (hereinafter, also referred to as a polyisocyanate compound (III)). Examples of the polyisocyanate compound (III) include those described above as examples of the polyisocyanate compound (II).

Specific examples of the polyisocyanate compound (III) include Coronate HX (available from Nippon Polyurethane Industry Co., Ltd., isocyanurate structure of hexamethylene diisocyanate, NCO content 21.1%), Sumidur N3300 (available from Sumika Bayer Urethane Co., Ltd., isocyanurate structure of hexamethylene diisocyanate), Takenate D170N (available from Mitsui Chemicals, Inc., isocyanurate structure of hexamethylene diisocyanate), Sumidur N3800 (available from Sumika Bayer Urethane Co., Ltd., isocyanurate structure of hexamethylene diisocyanate, prepolymer), D-370N (available from Mitsui Chemicals, Inc., NCO content 25.0%), AE-700 (available from Asahi Kasei Corp., NCO content 11.9%), and D-201 (available from Mitsui Chemicals, Inc., NCO content 15.8%).

The polyisocyanate compound used may be a polyisocyanate compound derived from isophorone diisocyanate (IPDI) (hereinafter, also referred to as a polyisocyanate compound (IV)).

Examples of the polyisocyanate compound (IV) include an adduct obtainable by addition polymerization of isophorone diisocyanate and an aliphatic polyhydric alcohol having three or more hydroxy groups, an isocyanurate structure (nurate structure) including isophorone diisocyanate, and a biuret of isophorone diisocyanate.

The adduct is preferably one having a structure represented by the following formula (9):

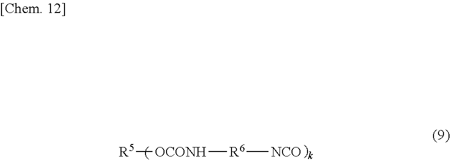

wherein R⁵ is a C3-C20 aliphatic hydrocarbon group; R⁶ is a group represented by the following formula (10):

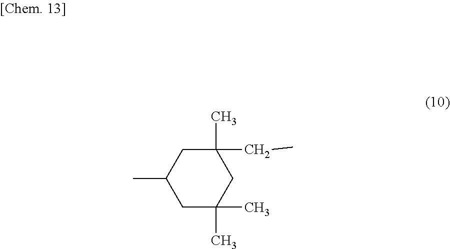

and k is an integer of 3 to 20.

R⁵ in the formula (9) is a hydrocarbon group based on the aliphatic polyhydric alcohol having three or more hydroxy groups, and is preferably a C3-C10 aliphatic hydrocarbon group, more preferably a C3-C6 aliphatic hydrocarbon group.

The symbol k refers to the number of hydroxy groups in the aliphatic polyhydric alcohol having three or more hydroxy groups. The symbol k is more preferably an integer of 3 to 10, still more preferably an integer of 3 to 6.

The isocyanurate structure is one having one or two or more isocyanurate rings represented by the following formula (2):

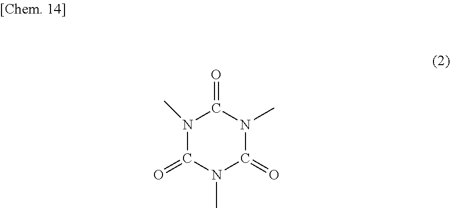

in the molecule.

Examples of the isocyanurate structure include a trimer obtainable by trimerization of isophorone diisocyanate, a pentamer obtainable by pentamerization thereof, and a heptamer obtainable by heptamerization thereof.

Preferred among these is a trimer represented by the following formula (11):

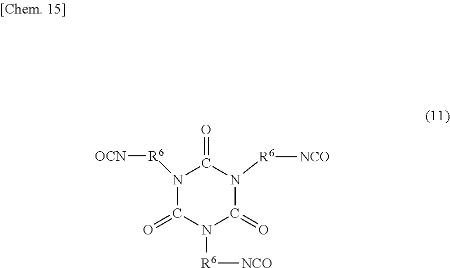

wherein R⁶ is defined as described for R⁶ in the formula (9). In other words, the isocyanurate structure is preferably a trimer of isophorone diisocyanate.

The biuret is a compound having a structure represented by the following formula (12):

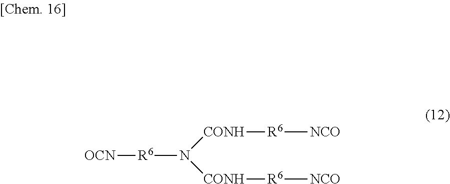

(wherein R⁶ is defined as described for R⁶ in the formula (9)) and is obtainable by trimerization of isophorone diisocyanate under the conditions different from those for producing the isocyanurate structure.

In particular, the polyisocyanate compound (IV) preferably includes at least one selected from the group consisting of the adduct and the isocyanurate structure. In other words, the polyisocyanate compound (IV) preferably includes at least one selected from the group consisting of an adduct obtainable by addition polymerization of isophorone diisocyanate and an aliphatic polyhydric alcohol having three or more hydroxy groups and an isocyanurate structure including isophorone diisocyanate.

In the case where the polyisocyanate compound (IV) is an adduct of isophorone diisocyanate and an aliphatic polyhydric alcohol having three or more hydroxy groups, specific examples of this aliphatic polyhydric alcohol having three or more hydroxy groups include trihydric alcohols such as glycerol, trimethylolpropane (TMP), 1,2,6-hexanetriol, trimethylolethane, 2,4-dihydroxy-3-hydroxymethylpentane, 1,1,1-tris(bishydroxymethyl) propane, and 2,2-bis(hydroxymethyl) butanol-3; tetrahydric alcohols such as pentaerythritol and diglycerol; pentahydric alcohols (pentits) such as arabit, ribitol, and xylitol; and hexahydric alcohols (hexits) such as sorbit, mannit, galactitol, and allodulcit. Particularly preferred among these are trimethylolpropane and pentaerythritol.

Addition polymerization of isophorone diisocyanate and the aforementioned aliphatic polyhydric alcohol having three or more hydroxy groups can provide an adduct that can be suitably used in the present invention.

A specific example of the adduct that can be suitably used in the present invention is a compound represented by the following formula (13):

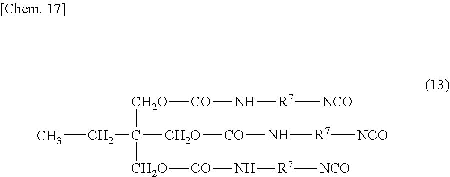

wherein R⁷ is a group represented by the following formula (10):

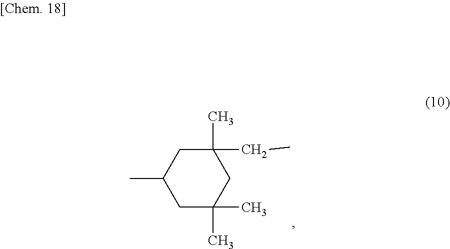

i.e., a polyisocyanate compound obtainable by addition polymerization of isophorone diisocyanate and trimethylol propane (TMP).

Commercially available products of a polyisocyanate compound (adduct of isophorone diisocyanate and TMP) represented by the formula (13) include Takenate D140N (available from Mitsui Chemicals, Inc., NCO content 11%).

Commercially available products of the isocyanurate structure including isophorone diisocyanate include Desmodur Z4470 (available from Sumika Bayer Urethane Co., Ltd., NCO content 11%).

The polyisocyanate compound used may be a water-dispersible polyisocyanate compound. The water-dispersible polyisocyanate compound refers to a polyisocyanate compound that can form an aqueous dispersion when fed into and stirred in an aqueous medium. Examples of this water-dispersible polyisocyanate compound include (1) a mixture of a hydrophobic polyisocyanate and a hydrophilic group-containing polyisocyanate, (2) a mixture of a hydrophobic polyisocyanate and a hydrophilic group-containing dispersant free from an isocyanate group, and (3) a hydrophilic group-containing polyisocyanate alone. The hydrophilic group herein refers to an anionic group, a cationic group, or a nonionic group. The water-dispersible polyisocyanate compound is particularly preferably a hydrophilic group-containing polyisocyanate.

The hydrophobic polyisocyanate refers to one free from a hydrophilic group. Examples thereof include aliphatic diisocyanates such as 1,4-tetramethylene diisocyanate, ethyl (2,6-diisocyanato) hexanoate, 1,6-hexamethylene diisocyanate, 1,12-dodecamethylene diisocyanate, and 2,2,4- or 2,4,4-trimethylhexamethylene diisocyanate; aliphatic triisocyanates such as 1,3,6-hexamethylene triisocyanate, 1,8-diisocyanato-4-isocyanatomethyl octane, and 2-isocyanatoethyl (2,6-diisocyanato) hexanoate; alicyclic diisocyanates such as 1,3-bis(isocyanatomethylcyclohexane), 1,4-bis(isocyanatomethylcyclohexane), 1,3-diisocyanatocyclohexane, 1,4-diisocyanatocyclohexane, 3,5,5-trimethyl (3-isocyanatomethyl)cyclohexyl isocyanate, dicyclohexylmethane-4,4′-diisocyanate, 2,5-diisocyanatomethylnorbornane, and 2,6-diisocyanatomethylnorbornane; alicyclic triisocyanates such as 2,5-diisocyanatomethyl-2-isocyanatopropylnorbornane and 2,6-diisocyanatomethyl-2-isocyanatopropylnorbornane; aralkylene diisocyanates such as m-xylylene diisocyanate and α,α,α′,α′-tetramethyl-m-xylylene diisocyanate; aromatic diisocyanates such as m- or p-phenylene diisocyanate, tolylene-2,4-diisocyanate, tolylene-2,6-diisocyanate, diphenylmethane-4,4′-diisocyanate, naphthalene-1,5-diisocyanate, diphenyl-4,4′-diisocyanate, 4,4′-diisocyanato-3,3′-dimethyldiphenyl, 3-methyl-diphenylmethane-4,4′-diisocyanate, and diphenylether-4,4′-diisocyanate; aromatic triisocyanates such as triphenylmethane triisocyanate and tris(isocyanatophenyl)thiophosphate; polyisocyanates having a uretdione structure obtainable by cyclodimerizing isocyanate groups of any of the diisocyanates and the triisocyanates; polyisocyanates having an isocyanurate structure obtainable by cyclotrimerizing isocyanate groups of any of the diisocyanates and the triisocyanates; polyisocyanates having a biuret structure obtainable by reacting any of the diisocyanates and the triisocyanates with water; polyisocyanates having an oxadiazine trione structure obtainable by reacting any of the diisocyanates and the triisocyanates with carbon dioxide; and polyisocyanates having an allophanate structure.

Examples of the hydrophilic group-containing polyisocyanate include polyether, polyester, polyurethane, a vinyl polymer, alkyd resin, fluororesin, and silicon resin, each containing a hydrophilic group and an isocyanate group. Owing to its good dispersibility in water, preferred among these is polyether or a vinyl polymer containing a hydrophilic group and an isocyanate group, and more preferred is polyether containing a hydrophilic group and an isocyanate group. One of these hydrophilic group-containing polyisocyanates may be used alone or two or more thereof may be used in combination.

The hydrophilic group-containing dispersant free from an isocyanate group used may be, for example, an anion surfactant or a cationic surfactant.

The anion surfactant suitably used may be a carboxylate surfactant, a sulfate surfactant, a sulfonate surfactant, or a phosphate surfactant. Examples thereof include ammonium alkyl benzenesulfonate, sodium alkylsulfate, sodium alkyl diphenyl ether disulfonate, sodium dialkyl sulfosuccinate, and alkyl phosphate.

The cationic surfactant suitably used may be a quaternary ammonium salt, a pyridinium salt, or an imidazolinium salt. Examples thereof include alkyl trimethyl ammonium bromide, alkyl pyridinium bromide, and imidazolinium laurate.

The hydrophilic group-containing polyisocyanate is preferably one having an aliphatic diisocyanate or an alicyclic diisocyanate in its skeleton. To achieve an improved 60° gloss, more preferred is use of a polyisocyanate containing at least an aliphatic diisocyanate in its skeleton. To achieve improved weather resistance, still more preferred is combination use of a polyisocyanate containing an aliphatic diisocyanate in its skeleton and a polyisocyanate containing an alicyclic diisocyanate in its skeleton.

The polyisocyanate containing an aliphatic diisocyanate in its skeleton is particularly preferably a polyisocyanate containing hexamethylene diisocyanate (HDI) in its skeleton. The polyisocyanate containing an alicyclic diisocyanate in its skeleton is particularly preferably a polyisocyanate containing isophorone diisocyanate (IPDI) in its skeleton.

Commercially available products of a water-dispersible polyisocyanate compound containing a polyisocyanate compound having a hexamethylene diisocyanate (HDI) skeleton include Bayhydur XP2700 (available from Covestro AG, NCO content 10.6%), Bayhydur 3100 (available from Covestro AG, NCO content 17.4%), Bayhydur XP2655 (available from Covestro AG, NCO content 21.2%), Bayhydur 305 (available from Covestro AG, NCO content 16.2%), Duranate WT31-100 (available from Asahi Kasei Corp., NCO content 17.4%), and Duranate WT20-100 (available from Asahi Kasei Corp., NCO content 14.3%).

Commercially available products of a water-dispersible polyisocyanate compound containing a polyisocyanate compound having an isophorone diisocyanate (IPDI) skeleton include Bayhydur 401-70MPA/X (available from Covestro AG, NCO content 9.4%), Easaqua XD803 (available from Vencorex, NCO content 12.2%), Easaqua XD870 (available from Vencorex, NCO content 12.4%), Easaqua XD401 (available from Vencorex, NCO content 15.8%), and Duranate WR80-70P (available from Asahi Kasei Corp., NCO content 9.2%).

In particular, the polyisocyanate compound is preferably a water-dispersible polyisocyanate compound.

The polyisocyanate compound may be combined with an organic solvent for use. A polyisocyanate compound combined with an organic solvent has a low viscosity, so that it is easy to handle and is easily dispersed in water. In this case, the organic solvent needs to be free from a functional group reactive with an isocyanate group. The organic solvent also needs to have miscibility with the polyisocyanate compound used.

Examples of this organic solvent include: ester compounds such as ethyl acetate, propyl acetate, isopropyl acetate, butyl acetate, isobutyl acetate, pentyl acetate, methoxypropyl acetate, 3-methoxybutyl acetate, 2-ethylbutyl acetate, 2-ethylhexyl acetate, cyclohexyl acetate, methyl propionate, butyl propionate, butyl butyrate, dioctyl adipate, and diisopropyl glutarate; ether compounds such as diisopropyl ether, dibutyl ether, dioxane, and diethoxyethane; ketone compounds such as 2-pentanone, 3-pentanone, 2-hexanone, methyl isobutyl ketone, 2-heptanone, 4-heptanone, diisobutyl ketone, isophorone, cyclohexanone, and methyl cyclohexanone; aromatic compounds such as benzene, toluene, xylene, ethylbenzene, butylbenzene, and p-cymene; polyethylene glycol dialkyl ether-based compounds such as diethylene glycol dimethyl ether, diethylene glycol diethyl ether, triethylene glycol dimethyl ether, and dipropylene glycol dimethyl ether; polyethylene glycol dicarboxylate-based compounds such as diethylene glycol diacetate; and diethylene glycol monoalkyl ether monocarboxylates such as diethylene glycol monoethyl ether monoacetate and diethylene glycol monobutyl ether acetate.

The amount of the curing agent added is preferably 0.1 to 5 equivalents, more preferably 0.5 to 1.5 equivalents per equivalent of the curable functional group in the fluorine-containing polymer.

The hydroxy group in the fluorine-containing polymer and the isocyanate group in the polyisocyanate compound have an equivalent ratio (NCO/OH) of preferably 0.1 or higher, more preferably 0.6 or higher, still more preferably 0.8 or higher, while preferably 5 or lower, more preferably 3 or lower, still more preferably 1.5 or lower.

An equivalent ratio within this range tends to lead to a high 60° gloss as well as good dirt resistance and good weather resistance.

The coating material composition of the disclosure may further contain an additive. Examples of the additive include a resin (other than the fluorine-containing polymer), a curing accelerator, a pigment, a dispersant, a film-forming aid, a thickening agent, a preservative, a fluidity improver, a leveling agent, an antifoam, an anti-gelling agent, an ultraviolet absorber, an antioxidant, a hydrophilizing agent, a matting agent, an adhesion promoter, a flame retarder, a hindered amine photostabilizer, and crosslinked resin particles.

The coating material composition of the disclosure may be free from an organic solvent or may contain a small amount of an organic solvent.

The amount of the organic solvent, when contained, is preferably 15.0% by mass or less, more preferably 10.0% by mass or less, still more preferably 8.0% by mass or less, further preferably 6.0% by mass or less, particularly preferably 5.0% by mass or less of the coating material composition. The amount may be 0.01% by mass or more.

Examples of the organic solvent include the same as the organic solvents that may be used in the aqueous dispersion of the disclosure.

Applying the coating material composition of the disclosure to a substrate, for example, and optionally drying and curing the coating material composition can provide a film.

The disclosure also relates to a film containing the coating material composition of the disclosure.

The film of the disclosure has excellent weather resistance and excellent hardness, as well as excellent salt water resistance. Thus, the film of the disclosure has excellent heavy duty performance.

The film of the disclosure is also excellent in gloss, chemical resistance, alkali resistance, solvent resistance, dirt resistance, durability, initial water resistance, ease of drying, and appearance.

The disclosure also relates to a coated article including: a substrate; and the film of the disclosure provided on the substrate.

The film of the disclosure may be a non-cured film or may be a cured film. To enhance the aforementioned effects, a cured film is preferred.

The coating material composition, when containing a curing agent, is curable at room temperature. Curing may be promoted by heating.

The drying and curing may be performed at 10° C. to 300° C., commonly 100° C. to 200° C., for 30 seconds to 3 days. The film after drying and curing may be aged, which is commonly performed at 20° C. to 300° C. and completed within 1 minute to 3 days.

Examples of an application method include spray coating, roller coating, dip (immersion) coating, impregnation coating, spin flow coating, curtain flow coating, application with a roller, brush, or doctor blade, and electrodeposition.

Examples of the material of the substrate include metal, resin, ceramic, glass, concrete, stone, wood, and paper.

Examples of the metal include iron; stainless steel such as SUS304, SUS316L, and SUS403; aluminum; and a plated steel sheet such as a zinc-plated or aluminum-plated steel sheet. Examples of the ceramic include earthenware, porcelain, alumina material, zirconia material, and silicon oxide material. Examples of the resin include polyethylene terephthalate resin, polycarbonate resin, silicone resin, fluorosilicone resin, polyamide resin, polyamide-imide resin, polyimide resin, polyester resin, epoxy resin, polyphenylene sulfide resin, phenol resin, acrylic resin, and polyether sulfone resin.

To achieve good weather resistance, the film has a thickness of preferably 0.5 μm or greater, more preferably 10 μm or greater, still more preferably 15 μm or greater. The thickness is also preferably 200 μm or smaller, more preferably 100 μm or smaller.

A base coat layer (primer layer) may be provided between the substrate and the film, or a base coat layer and/or an intermediate coat layer may be provided therebetween. A coating material for the base coat layer used and a coating material for the intermediate coat layer used may be either a solvent-based coating material or a water-based coating material. Specific examples thereof include coating materials such as epoxy resin, modified epoxy resin, acrylic resin, acrylic modified epoxy resin, urethane resin, polyolefin resin, and polyester resin.

Commercially available products thereof include EPOMARINE PRIMER (available from Kansai Paint Co., Ltd.), HI-PON 20 DECHLO (available from Nippon Paint Co., Ltd.), HI-PON 20 FINE (available from Nippon Paint Co., Ltd.), water-based EPOALL (available from DNT Co., Ltd.), EPONICS #30 Undercoat HB (available from DNT Co., Ltd.), CELATECT U UNDERCOAT (available from Kansai Paint Co., Ltd.), DUFLON 100 MIDDLE COAT K (available from Nippon Paint Co., Ltd.), and water-based EPONICS Intermediate coat (available from DNT Co., Ltd.).

The coating material composition of the disclosure is useful for a variety of coating material compositions such as weather-resistant coating material, electrodepositing coating material, coating material for coil coating, coating material for automobiles, anti-graffiti coating material, and heavy duty coating material. The film and coated article of the disclosure can be suitably used for applications that require the aforementioned coating material.

In particular, the coating material composition of the disclosure can be suitably used for a heavy duty coating material. The coating material composition is particularly suitable as a heavy duty coating material for a structure that may be in contact with salt water or that may be corroded by salt water. The structure includes not only stationary structures such as bridge piers and water channels, but also moving structures such as ships.

Examples of the structure include: overwater or underwater structures such as bridges, concrete blocks, tetrapods, breakwaters, and pipelines; port facilities such as watergates, offshore tanks, and floating piers; sea floor work facilities such as seabed drilling equipment and submarine communications cable facilities; conduits, condensate pipes, water chambers, intakes, and outlets in thermal power, atomic power, or tide power generation facilities or ocean thermal energy conversion facilities; ship structures or attachments such as an exterior, screw, propeller, and anchor of a ship; and articles used on or in water.

The disclosure relates to an aqueous dispersion containing a fluorine-containing polymer that contains: a polymerized unit (a) based on a fluorine-containing monomer; a polymerized unit (b) based on a carboxy group-containing monomer; and a polymerized unit (c) based on a hydroxy group-containing monomer, the polymerized unit (b) being contained in an amount of 4.0 to 14.0 mol % of all polymerized units and the polymerized unit (c) being contained in an amount of 14.0 to 35.0 mol % of all polymerized units.

The disclosure also relates to an aqueous dispersion containing: a fluorine-containing polymer that contains a polymerized unit (a) based on a fluorine-containing monomer and a polymerized unit (b) based on a carboxy group-containing monomer; and a surfactant.

The surfactant is preferably a surfactant containing a polycyclic hydrocarbon group.

The fluorine-containing polymer preferably has a glass transition temperature of 30° C. to 60° C.

The fluorine-containing polymer preferably has a number average molecular weight of 3000 to 50000.

Preferably, any or all of carboxy groups in the polymerized unit (b) are in the form of a salt.

The aqueous dispersion preferably further contains an organic solvent in an amount of 2.0% by mass or less of the aqueous dispersion.

The aqueous dispersion preferably further contains an anion surfactant in an amount of 10.0% by mass or less relative to the fluorine-containing polymer.

The aqueous dispersion preferably further contains a nonionic surfactant in an amount of 10.0% by mass or less relative to the fluorine-containing polymer.

The disclosure also relates to a coating material composition containing the aqueous dispersion.

The coating material composition preferably further contains a curing agent.

In the coating material composition, preferably, the curing agent contains a polyisocyanate compound containing an aliphatic diisocyanate and/or an alicyclic diisocyanate in a skeleton thereof.

The coating material composition preferably further contains an organic solvent in an amount of 15.0% by mass or less of the coating material composition.

The disclosure also relates to a film containing the coating material composition.

The disclosure also relates to a coated article including: a substrate; and the film provided on the substrate.

In the coated article, preferably, the film is provided on the substrate with a base coat layer and/or an intermediate coat layer in between.

### EXAMPLES

The disclosure is more specifically described hereinbelow with reference to examples, but the disclosure is not limited to these examples.

The parameters were determined by the following methods. The symbol “-” in Tables 3 and 4 represents that the corresponding evaluation was not performed.

### (1) Amounts of Monomer Units of Polymer

The amounts (mol %) of the monomer units were calculated from the fluorine content (% by mass) determined by elemental analysis and composition analysis with the ¹HNMR spectrum.

### (2) Acid Value

The acid value was determined by the titration in conformity with JIS K5601.

### (3) Neutralization Acid Value

The neutralization acid value was calculated from the number of moles of the amine used for neutralization and the solid content of the resin.

### (4) Degree of Neutralization

The degree of neutralization refers to the ratio of the number of moles of the acid group after neutralization to the number of moles of the acid group before neutralization, and was calculated from the acid value and the neutralized acid value.

### (5) Hydroxyl Value

Using the actual amount and solid concentration of the hydroxy group monomer during polymerization, the hydroxyl value was calculated from the mass of the fluorine-containing polymer and the number of moles of the —OH group.

### (6) Number Average Molecular Weight (Mn)

Measurement device: GPC (model HLC-8020) available from Tosoh corp.

Measurement conditions: used were TSKgel columns: three GMHXL columns, one G2500HXL column, and one GRCXL-L column. The eluent used was tetrahydrofuran and the standard sample for molecular weight used was polystyrene with known molecular weight.

### (7) Glass Transition Temperature

In accordance with ASTM E1356-98, the glass transition temperature was determined by the midpoint method based on heat absorption in the second run using a DSC analysis device available from METTLER TOLEDO.

### Measurement Conditions

Temperature-increasing rate: 20° C./min
Amount of sample: 10 mg
Heat cycle: −50° C. to 150° C., heating, cooling, heating

### (8) Particle Size

The particle size was determined by dynamic light scattering using a device available from MicrotracBEL Corp. (model NanotracWave).

### (9) Amount of Residual Solvent

Measurement device: device available from Shimadzu Corp. (model GC-2014)

Measurement conditions: using DC-550 as a column, the amount of butyl acetate was measured.

### (10) Dispersion Stability

### <50° C. Storage Stability>

The aqueous dispersion was stored at 50° C., followed by check for the presence of change in the particle size of the fluorine-containing polymer from that before storage. The parameter was then evaluated by the following criteria. With the particle size before storage being taken as 100%, the particle size with a change of 120% or higher was defined as changed.
A: Particle size not changed for 15 weeks
B: Particle size not changed for 10 weeks
C: Particle size not changed for 5 weeks
D: Particle size changed in shorter than 5 weeks

### <Solvent Stability>

Ten grams of the aqueous dispersion was combined with 0.3 g of propylene glycol diacetate (PGDA), followed by stirring. The mixture was stored at 50° C. and the presence of precipitate was visually checked. The evaluation was performed by the following criteria.
A: No precipitate for 15 days
B: No precipitate for 5 days
C: No precipitate for 1 day
D: Precipitate generated in shorter than 1 day

### <Chemical Stability>

Ten grams of the aqueous dispersion was combined with 10 g of ion exchange water, then combined with 1 g of a 5 mass % CaCl₂) aqueous solution, followed by stirring in the up and down directions. After one minute, the presence of agglomerate was visually checked. The evaluation was performed by the following criteria.
A: No agglomerate generated
B: Some agglomerates generated but not gelled
C: Agglomerated and gelled

### <Physical Properties of Film>

### (11) Pencil Hardness

The pencil hardness was determined in conformity with JIS K5600.

### (12) 60° Gloss

The specular glossiness at 60° was determined in conformity with JIS K5600.

### (13) Initial Rain Resistance

The coating material composition was applied and dried for a prescribed period of time, and half of the specimen was then immersed in water for five minutes and raised. The appearance of the film and dissolution of the film into water were checked.
Good: Specimen not dissolved into water with a drying time of shorter than 20 minutes
Fair: Specimen not dissolved into water with a drying time of 20 to 60 minutes
Poor: Specimen dissolved into water with a drying time of longer than 60 minutes

### (14) Dirt Resistance

A 5% carbon black aqueous dispersion was applied to the specimen and dried at 50° C. for one hour. The workpiece was then rinsed with running water and the dirt resistance of the film was visually checked.
Good: Not changed
Fair: Slightly colored
Poor: Significantly colored

### (15) Ease of Drying

When the coating material composition applied was dried at room temperature, a finger was placed on the surface and the period of time until the coating material composition did not stick to the finger was measured.
Good: Dried in shorter than 60 minutes
Fair: Dried in 60 to 120 minutes
Poor: Dried in longer than 120 minutes

### (16) Appearance

The appearance of the specimen after application and drying was visually checked.
Good: Not changed
Fair: Slightly roughened on the surface
Poor: Significantly roughened on the surface

### <Weather Resistance Test>

An accelerated weather resistance test was performed for 2000 hours using EYE Super UV Tester W-13 (Light/Dew/Rest=11/11/1 HR=1 cycle) available from Iwasaki Electric Co., Ltd., and the gloss retention and the appearance were evaluated. The evaluation was performed by the following criteria.

### (17) Gloss Retention

The 60° gloss of the specimen after the weather resistance test was determined and the gloss retention relative to the initial gloss was evaluated.
Excellent: Gloss retention 90% or higher
Good: Gloss retention 80% or higher and lower than 90%
Fair: Gloss retention 60% or higher and lower than 80%
Poor: Gloss retention lower than 60%

### Example 1

A 6-L stainless steel autoclave was purged with nitrogen, charged with 1.4 kg of butyl acetate, 131.9 g of isopropyl alcohol, 19.8 g (0.1 mol) of vinyl benzoate (VBZ), 266.8 g (2.3 mol) of 4-hydroxybutyl vinyl ether (HBVE), 91.3 g (1.1 mol) of crotonic acid (CTA), 925.5 g (5.0 mol) of neononanoic acid vinyl ester (VV9), and 674.3 g (6.7 mol) of tetrafluoroethylene (TFE) under reduced pressure, and heated to 60° C. This was combined with a predetermined amount of a peroxide solution under stirring. After 5-hour stirring, the reaction mixture was cooled to room temperature and unreacted monomers were removed, followed by nitrogen purge. Thereby, 3.9 kg (solid content 46% by mass) of a product was obtained. This solution was combined with 2-dimethylaminoethanol, so that the carboxy groups were neutralized. Then, 2.7 kg of water was gradually added and the organic solvent was removed under reduced pressure, whereby an aqueous dispersion (solid content 40% by mass) was obtained. The properties of the resin and the properties of the dispersion were examined. The results are shown in Table 3.

A 200 ml polyethylene cup was charged with 68 g of the aqueous dispersion, as well as 0.4 g of a thickening agent (RM-8W), 0.5 g of an antifoam (BYK028), 0.5 g of a surface conditioner (BYK-345), and 0.4 g of ion exchange water, followed by 30.2 g of pigment paste prepared by mixing 70 g of white pigment (R-960), 0.3 g of an antifoam (BYK-028), 7.0 g of a dispersant (BYK-190), and 22.7 g of ion exchange water. The components were stirred using a homodisper at 1000 rpm for 20 minutes and then left to stand overnight. Thereby, a coating material composition was produced.

Fifty grams of the coating material composition was combined with a water-dispersible polyisocyanate compound (dilution of Bayhydur 305 (available from Covestro AG) in 3-methoxybutyl acetate to a solid content of 80%) under stirring at 500 rpm such that the NCO/OH ratio was as shown in Table 3, followed by stirring for about five minutes. This mixture was filtered through a mesh and applied, using an applicator, to a steel plate (SUS304) pre-coated with a strong solvent modified epoxy base coating material and a strong solvent urethane coating material, whereby a coated plate was produced. This was left to stand and cured at room temperature for seven days, whereby a specimen was prepared. The physical properties of the film were then examined. The results are shown in Table 3.

### Examples 2 to 17 and Comparative Examples 1 and 2

An aqueous dispersion, a coating material composition, and a coated plate were produced and the properties thereof were evaluated in the same manner as in Example 1 except that the compounds and conditions shown in any of the Tables 1 to 4 were used. The results are shown in Tables 1 to 4.

### Example 18

Fifty grams of the coating material composition produced in Example 12 was combined with a water-dispersible polyisocyanate compound (Easaqua XD803 (available from Vencorex)) under stirring at 500 rpm such that the NCO/OH ratio was as shown in Table 4, followed by stirring for about five minutes. This mixture was filtered through a mesh and applied, using an applicator, to a steel plate (SUS304) pre-coated with a strong solvent modified epoxy base coating material and a strong solvent urethane coating material, whereby a coated plate was produced. This was left to stand and cured at room temperature for seven days, whereby a specimen was prepared.

### Example 19

Fifty grams of the coating material composition produced in Example 12 was combined with a water-dispersible polyisocyanate compound (Easaqua XD803 (available from Vencorex)) under stirring at 500 rpm such that the NCO/OH ratio was as shown in Table 4, followed by stirring for about five minutes. This mixture was filtered through a mesh and applied, using an applicator, to a steel plate (SUS304) pre-coated with a strong solvent modified epoxy base coating material and a strong solvent urethane coating material, whereby a coated plate was produced. This was left to stand and cured at room temperature for seven days, whereby a specimen was prepared.

### Example 20

Fifty grams of the coating material composition produced in Example 12 was combined with a water-dispersible polyisocyanate compound (Easaqua XD803 (available from Vencorex)) under stirring at 500 rpm such that the NCO/OH ratio was as shown in Table 4, followed by stirring for about five minutes. This mixture was filtered through a mesh and applied, using an applicator, to a steel plate (SUS304) pre-coated with a strong solvent modified epoxy base coating material and a strong solvent urethane coating material, whereby a coated plate was produced. This was left to stand and cured at room temperature for seven days, whereby a specimen was prepared.

### Example 21

Fifty grams of the coating material composition produced in Example 12 was combined with a water-dispersible polyisocyanate compound (mixture of WR80-70P (available from Asahi Kasei Corp.) and WT20-100 (available from Asahi Kasei Corp.), mass ratio 8:2) under stirring at 500 rpm such that the NCO/OH ratio was as shown in Table 4, followed by stirring for about five minutes. This mixture was filtered through a mesh and applied, using an applicator, to a steel plate (SUS304) pre-coated with a strong solvent modified epoxy base coating material and a strong solvent urethane coating material, whereby a coated plate was produced. This was left to stand and cured at room temperature for seven days, whereby a specimen was prepared.

### Example 22

Fifty grams of the coating material composition produced in Example 12 was combined with a water-dispersible polyisocyanate compound (mixture of Easaqua XD803 (available from Vencorex) and dilution of Duranate TLA-100 (available from Asahi Kasei Corp.) in dipropylene glycol dimethyl ether to a solid content of 60%, mass ratio 8:2) under stirring at 500 rpm such that the NCO/OH ratio was as shown in Table 4, followed by stirring for about five minutes. This mixture was filtered through a mesh and applied, using an applicator, to a steel plate (SUS304) pre-coated with a strong solvent modified epoxy base coating material and a strong solvent urethane coating material, whereby a coated plate was produced. This was left to stand and cured at room temperature for seven days, whereby a specimen was prepared.

### Example 23

Fifty grams of the coating material composition produced in Example 12 was combined with a water-dispersible polyisocyanate compound (mixture of dilution of Bayhydur 305 (available from Covestro AG) in 3-methoxybutyl acetate to a solid content of 80% and Bayhydur 401-70 (available from Covestro AG), mass ratio 3:7) under stirring at 500 rpm such that the NCO/OH ratio was as shown in Table 4, followed by stirring for about five minutes. This mixture was filtered through a mesh and applied, using an applicator, to a steel plate (SUS304) pre-coated with a strong solvent modified epoxy base coating material and a strong solvent urethane coating material, whereby a coated plate was produced. This was left to stand and cured at room temperature for seven days, whereby a specimen was prepared.

### Example 24

Fifty grams of the coating material composition produced in Example 12 was combined with a water-dispersible polyisocyanate compound (mixture of dilution of Bayhydur 305 (available from Covestro AG) in 3-methoxybutyl acetate to a solid content of 80% and Bayhydur 401-70 (available from Covestro AG), mass ratio 5:5) under stirring at 500 rpm such that the NCO/OH ratio was as shown in Table 4, followed by stirring for about five minutes. This mixture was filtered through a mesh and applied, using an applicator, to a steel plate (SUS304) pre-coated with a strong solvent modified epoxy base coating material and a strong solvent urethane coating material, whereby a coated plate was produced. This was left to stand and cured at room temperature for seven days, whereby a specimen was prepared.

### Example 25

Fifty grams of the coating material composition produced in Example 12 was combined with a water-dispersible polyisocyanate compound (mixture of dilution of Bayhydur 305 (available from Covestro AG) in 3-methoxybutyl acetate to a solid content of 80% and Bayhydur 401-70 (available from Covestro AG), mass ratio 7:3) under stirring at 500 rpm such that the NCO/OH ratio was as shown in Table 4, followed by stirring for about five minutes. This mixture was filtered through a mesh and applied, using an applicator, to a steel plate (SUS304) pre-coated with a strong solvent modified epoxy base coating material and a strong solvent urethane coating material, whereby a coated plate was produced. This was left to stand and cured at room temperature for seven days, whereby a specimen was prepared.

### Example 26

Fifty grams of the coating material composition produced in Example 12 was combined with a water-dispersible polyisocyanate compound (Easaqua XD803 (available from Vencorex)) under stirring at 500 rpm such that the NCO/OH ratio was as shown in Table 4, followed by stirring for about five minutes. This mixture was filtered through a mesh and applied, using an applicator, to a steel plate (SUS304) pre-coated with a strong solvent modified epoxy base coating material and a strong solvent urethane coating material, whereby a coated plate was produced. This was left to stand and cured at room temperature for seven days, whereby a specimen was prepared.

### Example 27

Fifty grams of the coating material composition produced in Example 12 was combined with a water-dispersible polyisocyanate compound (Bayhydur 401-70MPA/X (available from Covestro AG)) under stirring at 500 rpm such that the NCO/OH ratio was as shown in Table 4, followed by stirring for about five minutes. This mixture was filtered through a mesh and applied, using an applicator, to a steel plate (SUS304) pre-coated with a strong solvent modified epoxy base coating material and a strong solvent urethane coating material, whereby a coated plate was produced. This was left to stand and cured at room temperature for seven days, whereby a specimen was prepared.

The properties of the aqueous dispersions, coating material compositions, and coated plates of Examples 18 to 27 were also evaluated. The results are shown in Tables 2 and 4.

TABLE 1

| | | | | Ex. 1 | Ex. 2 | Ex. 3 | Ex. 4 | Ex. 5 | Ex. 6 |
|---|---|---|---|---|---|---|---|---|---|
| Composition | Composition | (a) | TFE | 44.3 | 44.8 | 44.0 | 43.0 | 41.6 | 46.1 |
| of resin | (mol %) | | HFP | — | — | — | — | — | — |
| | | | CTFE | — | — | — | — | — | — |
| | | (d) | VV9 | 32.9 | 34.4 | 34.1 | 27.1 | 22.9 | 19.7 |
| | | (e) | VBZ | 0.9 | 0.9 | 0.9 | 0.8 | 0.8 | 0.8 |
| | | (c) | HBVE | 15.0 | 15.2 | 17.0 | 22.4 | 21.7 | 28.0 |
| | | (b) | CTA | 6.9 | 4.7 | 4.0 | 6.7 | 13.0 | 5.4 |
| | | | UDA | — | — | — | — | — | — |
| | | | total | 100.0 | 100.0 | 100.0 | 100.0 | 100.0 | 100.0 |
| Composition | Composition | (a) | TFE | 34.2 | 34.2 | 33.5 | 34.2 | 34.3 | 38.2 |
| of resin | (mass %) | | HFP | — | — | — | — | — | — |
| | | | CTFE | — | — | — | — | — | — |
| | | (d) | VV9 | 46.7 | 48.2 | 47.8 | 39.5 | 34.7 | 30.1 |
| | | (e) | VBZ | 1.0 | 1.0 | 1.0 | 1.0 | 1.0 | 1.0 |
| | | (c) | HBVE | 13.5 | 13.5 | 15.0 | 20.7 | 20.8 | 26.9 |
| | | (b) | CTA | 4.6 | 3.1 | 2.6 | 4.6 | 9.2 | 3.8 |
| | | | UDA | — | — | — | — | — | — |
| | | | total | 100.0 | 100.0 | 100.0 | 100.0 | 100.0 | 100.0 |
| Composition | Type of amine | | | DMEA | DMEA | DMEA | DMEA | DMEA | DMEA |
| of dispersion | Neutralization | | Degree of | 60 | 80 | 90 | 45 | 23 | 53 |
| | | | neutralization | | | | | | |
| | | | (%) | | | | | | |
| | | (b-1) | Non-neutralized | 2.8 | 0.9 | 0.4 | 3.7 | 10.0 | 2.5 |
| | | | acid (mol %) | | | | | | |
| | | (b-2) | Neutralized | 4.1 | 3.8 | 3.6 | 3.0 | 3.0 | 2.9 |
| | | | acid (mol %) | | | | | | |
| | Surfactant 1 | | mass %/resin | — | — | — | — | — | — |
| | Surfactant 2 | | mass %/resin | — | — | — | — | — | — |
| | Surfactant 3 | | mass %/resin | — | — | — | — | — | — |
| | | | | Ex. 7 | Ex. 8 | Ex. 9 | Ex. 10 | Ex. 11 | Ex. 12 |
| Composition | Composition | (a) | TFE | — | — | 44.7 | 44.8 | 42.4 | 42.4 |
| of resin | (mol %) | | HFP | 33.0 | — | — | — | — | — |
| | | | CTFE | — | 39.0 | — | — | — | — |
| | | (d) | VV9 | 27.1 | 27.2 | 24.8 | 19.8 | 28.4 | 28.4 |
| | | (e) | VBZ | 0.9 | 0.8 | 0.6 | 0.6 | 0.9 | 0.9 |
| | | (c) | HBVE | 33.0 | 26.0 | 25.6 | 30.8 | 23.7 | 23.7 |
| | | (b) | CTA | 6.0 | 7.0 | 4.3 | 4.0 | 4.6 | 4.6 |
| | | | UDA | — | — | — | — | — | — |
| | | | total | 100.0 | 100.0 | 100.0 | 100.0 | 100.0 | 100.0 |
| Composition | Composition | (a) | TFE | — | — | 34.2 | 34.2 | 34.2 | 34.2 |
| of resin | (mass %) | | HFP | 34.3 | — | — | — | — | — |
| | | | CTFE | — | 34.2 | — | — | — | — |
| | | (d) | VV9 | 34.6 | 37.7 | 34.8 | 30.6 | 41.0 | 41.0 |
| | | (e) | VBZ | 0.9 | 0.9 | 1.0 | 1.0 | 1.0 | 1.0 |
| | | (c) | HBVE | 26.6 | 22.7 | 26.9 | 31.1 | 20.7 | 20.7 |
| | | (b) | CTA | 3.6 | 4.5 | 3.1 | 3.1 | 3.1 | 3.1 |
| | | | UDA | — | — | — | — | — | — |
| | | | total | 100.0 | 100.0 | 100.0 | 100.0 | 100.0 | 100.0 |
| Composition | Type of amine | | | DMEA | DMEA | DMEA | DMEA | DMEA | DMEA |
| of dispersion | Neutralization | | Degree of | 60 | 48 | 62 | 60 | 70 | 70 |
| | | | neutralization | | | | | | |
| | | | (%) | | | | | | |
| | | (b-1) | Non-neutralized | 2.4 | 3.6 | 1.6 | 1.6 | 1.4 | 1.4 |
| | | | acid (mol %) | | | | | | |
| | | (b-2) | Neutralized | 3.6 | 3.4 | 2.7 | 2.4 | 3.2 | 3.2 |
| | | | acid (mol %) | | | | | | |

| | | | | | | | |
|---|---|---|---|---|---|---|---|
| Surfactant 1 | mass %/resin | — | — | — | — | — | 3.0 |
| Surfactant 2 | mass %/resin | — | — | — | — | — | — |
| Surfactant 3 | mass %/resin | — | — | — | — | — | — |

| | | | | Ex. 13 | Ex. 14 | Ex. 15 | Ex. 16 | Ex. 17 |
|---|---|---|---|---|---|---|---|---|
| Composition | Composition | (a) | TFE | 42.4 | 45.0 | 42.4 | 42.4 | 42.4 |
| of resin | (mol %) | | HFP | — | — | — | — | — |
| | | | CTFE | — | — | — | — | — |
| | | (d) | VV9 | 28.4 | 26.1 | 28.4 | 28.4 | 28.4 |
| | | (e) | VBZ | 0.9 | 0.9 | 0.9 | 0.9 | 0.9 |
| | | (c) | HBVE | 23.7 | 23.2 | 23.7 | 23.7 | 23.7 |
| | | (b) | CTA | 4.6 | — | 4.6 | 4.6 | 4.6 |
| | | | UDA | — | 4.8 | — | — | — |
| | | | total | 100.0 | 100.0 | 100.0 | 100.0 | 100.0 |
| Composition | Composition | (a) | TFE | 34.2 | 34.6 | 34.2 | 34.2 | 34.2 |
| of resin | (mass %) | | HFP | — | — | — | — | — |
| | | | CTFE | — | — | — | — | — |
| | | (d) | VV9 | 41.0 | 36.9 | 41.0 | 41.0 | 41.0 |
| | | (e) | VBZ | 1.0 | 1.0 | 1.0 | 1.0 | 1.0 |
| | | (c) | HBVE | 20.7 | 20.7 | 20.7 | 20.7 | 20.7 |
| | | (b) | CTA | 3.1 | — | 3.1 | 3.1 | 3.1 |
| | | | UDA | — | 6.8 | — | — | — |
| | | | total | 100.0 | 100.0 | 100.0 | 100.0 | 100.0 |
| Composition | Type of amine | | | DMEA | DMEA | DMEA | DMEA | DMEA |
| of dispersion | Neutralization | | Degree of | 70 | 72 | 70 | 70 | 70 |
| | | | neutralization | | | | | |
| | | | (%) | | | | | |
| | | (b-1) | Non-neutralized | 1.4 | 1.3 | 1.4 | 1.4 | 1.4 |
| | | | acid (mol %) | | | | | |
| | | (b-2) | Neutralized | 3.2 | 3.5 | 3.2 | 3.2 | 3.2 |
| | | | acid (mol %) | | | | | |

| | | | | | | |
|---|---|---|---|---|---|---|
| Surfactant 1 | mass %/resin | — | — | 1.5 | 2.0 | — |
| Surfactant 2 | mass %/resin | 3.0 | — | 1.5 | — | — |
| Surfactant 3 | mass %/resin | — | — | — | — | 3.0 |

TABLE 2

| | | | | Ex. 18 | Ex. 19 | Ex. 20 | Ex. 21 | Ex. 22 | Ex. 23 | Ex. 24 |
|---|---|---|---|---|---|---|---|---|---|---|
| Composition | Composition | (a) | TFE | 42.4 | 42.4 | 42.4 | 42.4 | 42.4 | 42.4 | 42.4 |
| of resin | (mol %) | | HFP | — | — | — | — | — | — | — |
| | | | CTFE | — | — | — | — | — | — | — |
| | | (d) | VV9 | 28.4 | 28.4 | 28.4 | 28.4 | 28.4 | 28.4 | 28.4 |
| | | (e) | VBZ | 0.9 | 0.9 | 0.9 | 0.9 | 0.9 | 0.9 | 0.9 |
| | | (c) | HBVE | 23.7 | 23.7 | 23.7 | 23.7 | 23.7 | 23.7 | 23.7 |
| | | (b) | CTA | 4.6 | 4.6 | 4.6 | 4.6 | 4.6 | 4.6 | 4.6 |
| | | | UDA | — | — | — | — | — | — | — |
| | | | total | 100.0 | 100.0 | 100.0 | 100.0 | 100.0 | 100.0 | 100.0 |
| Composition | Composition | (a) | TFE | 34.2 | 34.2 | 34.2 | 34.2 | 34.2 | 34.2 | 34.2 |
| of resin | (mass %) | | HFP | — | — | — | — | — | — | — |
| | | | CTFE | — | — | — | — | — | — | — |
| | | (d) | VV9 | 41.0 | 41.0 | 41.0 | 41.0 | 41.0 | 41.0 | 41.0 |
| | | (e) | VBZ | 1.0 | 1.0 | 1.0 | 1.0 | 1.0 | 1.0 | 1.0 |
| | | (c) | HBVE | 20.7 | 20.7 | 20.7 | 20.7 | 20.7 | 20.7 | 20.7 |
| | | (b) | CTA | 3.1 | 3.1 | 3.1 | 3.1 | 3.1 | 3.1 | 3.1 |
| | | | UDA | — | — | — | — | — | — | — |
| | | | total | 100.0 | 100.0 | 100.0 | 100.0 | 100.0 | 100.0 | 100.0 |
| Composition | Type of amine | | | DMEA | DMEA | DMEA | DMEA | DMEA | DMEA | DMEA |
| of dispersion | Neutralization | | Degree of | 70 | 70 | 70 | 70 | 70 | 70 | 70 |
| | | | neutralization | | | | | | | |
| | | | (%) | | | | | | | |
| | | (b-1) | Non-neutralized | 1.4 | 1.4 | 1.4 | 1.4 | 1.4 | 1.4 | 1.4 |
| | | | acid (mol %) | | | | | | | |
| | | (b-2) | Neutralized | 3.2 | 3.2 | 3.2 | 3.2 | 3.2 | 3.2 | 3.2 |
| | | | acid (mol %) | | | | | | | |

| | | | | | | | | |
|---|---|---|---|---|---|---|---|---|
| Surfactant 1 | mass %/resin | 3.0 | 3.0 | 3.0 | 3.0 | 3.0 | 3.0 | 3.0 |
| Surfactant 2 | mass %/resin | — | — | — | — | — | — | — |
| Surfactant 3 | mass %/resin | — | — | — | — | — | — | — |

| | | | | | | | Comp. | Comp. |
|---|---|---|---|---|---|---|---|---|
| | | | | Ex. 25 | Ex. 26 | Ex. 27 | Ex. 1 | Ex. 2 |
| Composition | Composition | (a) | TFE | 42.4 | 42.4 | 42.4 | 43.8 | 44.5 |
| of resin | (mol %) | | HFP | — | — | — | — | — |
| | | | CTFE | — | — | — | — | — |
| | | (d) | VV9 | 28.4 | 28.4 | 28.4 | 29.0 | 37.0 |
| | | (e) | VBZ | 0.9 | 0.9 | 0.9 | 0.9 | 0.9 |
| | | (c) | HBVE | 23.7 | 23.7 | 23.7 | 22.9 | 13.0 |
| | | (b) | CTA | 4.6 | 4.6 | 4.6 | 3.4 | 4.6 |
| | | | UDA | — | — | — | — | — |
| | | | total | 100.0 | 100.0 | 100.0 | 100.0 | 100.0 |
| Composition | Composition | (a) | TFE | 34.2 | 34.2 | 34.2 | 34.2 | 33.5 |
| of resin | (mass %) | | HFP | — | — | — | — | — |
| | | | CTFE | — | — | — | — | — |
| | | (d) | VV9 | 41.0 | 41.0 | 41.0 | 41.7 | 51.2 |
| | | (e) | VBZ | 1.0 | 1.0 | 1.0 | 1.0 | 1.0 |
| | | (c) | HBVE | 20.7 | 20.7 | 20.7 | 20.8 | 11.3 |
| | | (b) | CTA | 3.1 | 3.1 | 3.1 | 2.3 | 3.0 |
| | | | UDA | — | — | — | — | — |
| | | | total | 100.0 | 100.0 | 100.0 | 100.0 | 100.0 |
| Composition | Type of amine | | | DMEA | DMEA | DMEA | DMEA | DMEA |
| of dispersion | Neutralization | | Degree of | 70 | 70 | 70 | 100 | 100 |
| | | | neutralization | | | | | |
| | | | (%) | | | | | |
| | | (b-1) | Non-neutralized | 1.4 | 1.4 | 1.4 | 0.0 | 0.0 |
| | | | acid (mol %) | | | | | |
| | | (b-2) | Neutralized | 3.2 | 3.2 | 3.2 | 3.4 | 4.6 |
| | | | acid (mol %) | | | | | |

| | | | | | | |
|---|---|---|---|---|---|---|
| Surfactant 1 | mass %/resin | 3.0 | 3.0 | 3.0 | — | — |
| Surfactant 2 | mass %/resin | — | — | — | — | — |
| Surfactant 3 | mass %/resin | — | — | — | — | — |

TABLE 3

| | | | Ex. 1 | Ex. 2 | Ex. 3 | Ex. 4 | Ex. 5 | Ex. 6 |
|---|---|---|---|---|---|---|---|---|
| Properties of | Acid value | mgKOH/g | 30 | 20 | 17 | 30 | 60 | 25 |
| resin | Neutralized acid value | mgKOH/g | 18 | 16 | 15 | 14 | 14 | 13 |
| | Hydroxyl value | mgKOH/g | 65 | 65 | 73 | 100 | 100 | 130 |
| | Molecular weight Mn | | 11000 | 12000 | 12000 | 12000 | 12000 | 14000 |
| | Glass transition | ° C. | 43 | 44 | 43 | 41 | 39 | 39 |
| | temperature | | | | | | | |
| Properties of | Water dispersibility | | Good | Good | Good | Good | Good | Good |
| dispersion | | | | | | | | |
| NCO/OH | | | 1.2 | 1.2 | 1.2 | 1.2 | 1.2 | 1.2 |
| Curing agent | | | HDI | HDI | HDI | HDI | HDI | HDI |
| | Particle size | nm | 181 | 181 | 175 | 176 | 170 | 170 |
| | Amount of residual | mass % | 0.2 | 0.2 | 0.5 | 0.2 | 0.4 | 0.2 |
| | solvent (butyl acetate) | | | | | | | |
| | 50° C. Storage stability | | B | C | C | B | B | B |
| | Solvent stability | PGDA | B | B | B | B | B | B |
| | Chemical stability | 5% | B | B | B | B | B | B |
| | | CaCl2 | | | | | | |
| Physical | Pencil hardness | | F | HB | HB | HB | HB | F |
| properties of film | (scratch) | | | | | | | |
| | 60° Gloss | | 82 | 81 | 81 | 83 | 82 | 82 |
| | Initial rain resistance | | — | — | — | — | — | — |
| | Dirt resistance | | — | — | — | — | — | — |
| | Ease of drying | | Fair | Fair | Fair | Fair | Fair | Fair |
| | Appearance | | — | — | — | — | — | — |
| Weather | Gloss retention | | Good | Good | Good | Good | Good | Good |
| resistance test | | | | | | | | |
| | | | Ex. 7 | Ex. 8 | Ex. 9 | Ex. 10 | Ex. 11 | Ex. 12 |
| Properties of | Acid value | mgKOH/g | 23 | 30 | 20 | 20 | 20 | 20 |
| resin | Neutralized acid value | mgKOH/g | 14 | 14 | 12 | 12 | 14 | 14 |
| | Hydroxyl value | mgKOH/g | 128 | 110 | 130 | 150 | 100 | 100 |
| | Molecular weight Mn | | 13000 | 12000 | 11000 | 11000 | 11000 | 11000 |
| | Glass transition | ° C. | 37 | 45 | 33 | 35 | 40 | 40 |
| | temperature | | | | | | | |
| Properties of | Water dispersibility | | Good | Good | Good | Good | Good | Good |
| dispersion | | | | | | | | |
| NCO/OH | | | 1.2 | 1.2 | 1.2 | 1.2 | 1.2 | 1.2 |
| Curing agent | | | HDI | HDI | HDI | HDI | HDI | HDI |
| | Particle size | nm | 168 | 173 | 158 | 179 | 182 | 182 |
| | Amount of residual | mass % | 0.3 | 0.1 | 0.3 | 0.3 | 0.2 | 0.2 |
| | solvent (butyl acetate) | | | | | | | |
| | 50° C. Storage stability | | B | B | B | B | B | A |
| | Solvent stability | PGDA | B | B | B | B | B | A |
| | Chemical stability | 5% | B | B | B | B | B | A |
| | | CaCl2 | | | | | | |
| Physical | Pencil hardness | | B | F | H | H | H | F |
| properties of film | (scratch) | | | | | | | |
| | 60° Gloss | | 78 | 79 | 79 | 81 | 83 | 83 |
| | Initial rain resistance | | — | — | — | — | — | Good |
| | Dirt resistance | | — | — | — | — | — | Fair |
| | Ease of drying | | Fair | Fair | Fair | Fair | Fair | Fair |
| | Appearance | | — | — | — | — | Fair | Good |
| Weather | Gloss retention | | Good | Good | Good | Good | Good | Good |
| resistance test | | | | | | | | |

| | | | Ex. 13 | Ex. 14 | Ex. 15 | Ex. 16 | Ex. 17 |
|---|---|---|---|---|---|---|---|
| Properties of | Acid value | mgKOH/g | 20 | 21 | 20 | 20 | 20 |
| resin | Neutralized acid value | mgKOH/g | 14 | 15 | 14 | 14 | 14 |
| | Hydroxyl value | mgKOH/g | 100 | 100 | 100 | 100 | 100 |
| | Molecular weight Mn | | 11000 | 13000 | 11000 | 11000 | 11000 |
| | Glass transition | ° C. | 40 | 32 | 40 | 40 | 40 |
| | temperature | | | | | | |
| Properties of | Water dispersibility | | Good | Good | Good | Good | Good |
| dispersion | | | | | | | |
| NCO/OH | | | 1.2 | 1.2 | 1.2 | 1.2 | 1.2 |
| Curing agent | | | HDI | HDI | HDI | HDI | HDI |
| | Particle size | nm | 182 | 190 | 182 | 182 | 182 |
| | Amount of residual | mass % | 0.2 | 0.3 | 0.2 | 0.2 | 0.2 |
| | solvent (butyl acetate) | | | | | | |
| | 50° C. Storage stability | | A | C | A | A | B |
| | Solvent stability | PGDA | A | B | A | A | A |
| | Chemical stability | 5% | A | B | A | B | A |
| | | CaCl2 | | | | | |
| Physical | Pencil hardness | | F | 3B | F | F | F |
| properties of film | (scratch) | | | | | | |
| | 60° Gloss | | 83 | 75 | 83 | 82 | 82 |
| | Initial rain resistance | | — | — | — | — | — |
| | Dirt resistance | | — | — | — | — | — |
| | Ease of drying | | — | — | — | — | — |
| | Appearance | | — | — | — | — | — |
| Weather | Gloss retention | | Good | Good | Good | Good | Good |
| resistance test | | | | | | | |

TABLE 4

| | | | Ex. 18 | Ex. 19 | Ex. 20 | Ex. 21 | Ex. 22 | Ex. 23 |
|---|---|---|---|---|---|---|---|---|
| Properties of | Acid value | mgKOH/g | 20 | 20 | 20 | 20 | 20 | 20 |
| resin | Neutralized acid value | mgKOH/g | 14 | 14 | 14 | 14 | 14 | 14 |
| | Hydroxyl value | mgKOH/g | 100 | 100 | 100 | 100 | 100 | 100 |
| | Molecular weight Mn | | 11000 | 11000 | 11000 | 11000 | 11000 | 11000 |
| | Glass transition | ° C. | 40 | 40 | 40 | 40 | 40 | 40 |
| | temperature | | | | | | | |
| Properties of | Water dispersibility | | | | | | | |
| dispersion | | | | | | | | |
| NCO/OH | | | 1.2 | 1.5 | 0.8 | 1.2 | 1.2 | 1.2 |
| Curing agent | | | HDI + | HDI + | HDI + | HDI + | HDI + | HDI + |
| | | | IPDI | IPDI | IPDI | IPDI | IPDI | IPDI |
| | Particle size | nm | 182 | 182 | 182 | 182 | 182 | 182 |
| | Amount of residual | mass % | 0.2 | 0.2 | 0.2 | 0.2 | 0.2 | 0.2 |
| | solvent (butyl acetate) | | | | | | | |
| | 50° C. Storage stability | | A | A | A | A | A | A |
| | Solvent stability | PGDA | A | A | A | A | A | A |
| | Chemical stability | 5% | A | A | A | A | A | A |
| | | CaCl2 | | | | | | |
| Physical | Pencil hardness | | H | 2H | H | H | F | F |
| properties of film | (scratch) | | | | | | | |
| | 60° Gloss | | 83 | 83 | 71 | 76 | 85 | 71 |
| | Initial rain resistance | | Good | — | — | — | — | — |
| | Dirt resistance | | Good | Good | Good | Good | Good | Good |
| | Ease of drying | | Good | Good | Good | Good | Good | Good |
| | Appearance | | Good | Good | Good | Good | Good | Good |
| Weather | Gloss retention | | Excellent | Excellent | Excellent | Excellent | Excellent | Excellent |
| resistance test | | | | | | | | |

| | | | | | | | Comp. | Comp. |
|---|---|---|---|---|---|---|---|---|
| | | | Ex. 24 | Ex. 25 | Ex. 26 | Ex. 27 | Ex. 1 | Ex. 2 |
| Properties of | Acid value | mgKOH/g | 20 | 20 | 20 | 20 | 15 | 19 |
| resin | Neutralized acid value | mgKOH/g | 14 | 14 | 14 | 14 | 15 | 19 |
| | Hydroxyl value | mgKOH/g | 100 | 100 | 100 | 100 | 100 | 55 |
| | Molecular weight Mn | | 11000 | 11000 | 11000 | 11000 | 11000 | 10000 |
| | Glass transition | ° C. | 40 | 40 | 40 | 40 | 39 | 45 |
| | temperature | | | | | | | |
| Properties of | Water dispersibility | | | | | | Good | Good |
| dispersion | | | | | | | | |
| NCO/OH | | | 1.2 | 1.2 | 0.5 | 1.2 | 1.2 | 1.2 |
| Curing agent | | | HDI + | HDI + | HDI + | IPDI | HDI | HDI |
| | | | IPDI | IPDI | IPDI | | | |
| | Particle size | nm | 182 | 182 | 182 | 182 | 168 | 190 |
| | Amount of residual | mass % | 0.2 | 0.2 | 0.2 | 0.2 | 0.2 | 0.2 |
| | solvent (butyl acetate) | | | | | | | |
| | 50° C. Storage stability | | A | A | A | A | C | D |
| | Solvent stability | PGDA | A | A | A | A | D | D |
| | Chemical stability | 5% | A | A | A | A | C | C |
| | | CaCl2 | | | | | | |
| Physical | Pencil hardness | | F | F | B | H | HB | HB |
| properties of film | (scratch) | | | | | | | |
| | 60° Gloss | | 73 | 74 | 66 | 57 | 79 | 75 |
| | Initial rain resistance | | — | — | — | — | — | — |
| | Dirt resistance | | Good | Good | Fair | Good | — | — |
| | Ease of drying | | — | — | — | — | — | — |
| | Appearance | | — | Good | — | — | — | — |
| Weather | Gloss retention | | Excellent | Excellent | Fair | Fair | Good | Fair |
| resistance test | | | | | | | | |

The abbreviations in the tables indicate the following.
TFE: tetrafluoroethylene
HFP: hexafluoropropylene
CTFE: chlorotrifluoroethylene
VV9: neononanoic acid vinyl ester
VBZ: vinyl benzoate
HBVE: 4-hydroxybutyl vinyl ether
CTA: crotonic acid (trans-form)
UDA: undecylenic acid

Surfactant 1: polyoxyethylene styrenated phenyl ether sulfuric acid ester ammonium salt represented by the following formula

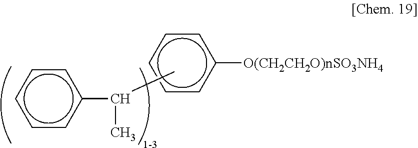

Surfactant 2: polyoxyethylene styrenated phenyl ether represented by the following formula

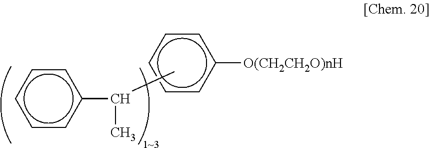

Surfactant 3: polyoxyethylene styrenated phenyl ether represented by the following formula

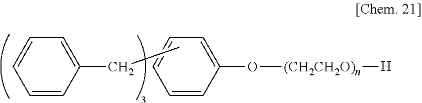

HDI: polyisocyanate compound having hexamethylene diisocyanate skeleton

IPDI: polyisocyanate compound having isophorone diisocyanate skeleton

1. An aqueous dispersion comprising a fluorine-containing polymer that contains:
a polymerized unit (a) based on a fluorine-containing monomer;
a polymerized unit (b) based on a carboxy group-containing monomer; and
a polymerized unit (c) based on a hydroxy group-containing monomer,
the polymerized unit (b) being contained in an amount of 4.0 to 14.0 mol % of all polymerized units and the polymerized unit (c) being contained in an amount of 14.0 to 35.0 mol % of all polymerized units.

2. An aqueous dispersion according to claim 1, further comprising a surfactant.

3. The aqueous dispersion according to claim 2,
wherein the surfactant is a surfactant containing a polycyclic hydrocarbon group.

4. The aqueous dispersion according to claim 1,
wherein the fluorine-containing polymer has a glass transition temperature of 30° C. to 60° C.

5. The aqueous dispersion according to claim 1,
wherein the fluorine-containing polymer has a number average molecular weight of 3000 to 50000.

6. The aqueous dispersion according to claim 1,
wherein any or all of carboxy groups in the polymerized unit (b) are in the form of a salt.

7. The aqueous dispersion according to claim 1, further comprising an organic solvent in an amount of 2.0% by mass or less of the aqueous dispersion.

8. The aqueous dispersion according to claim 1, further comprising an anion surfactant in an amount of 10.0% by mass or less relative to the fluorine-containing polymer.

9. The aqueous dispersion according to claim 1, further comprising a nonionic surfactant in an amount of 10.0% by mass or less relative to the fluorine-containing polymer.

10. A coating material composition comprising the aqueous dispersion according to claim 1.

11. The coating material composition according to claim 10, further comprising a curing agent.

12. The coating material composition according to claim 11,
wherein the curing agent contains a polyisocyanate compound containing an aliphatic diisocyanate and/or an alicyclic diisocyanate in a skeleton thereof.

13. The coating material composition according to claim 10, further comprising an organic solvent in an amount of 15.0% by mass or less of the coating material composition.

14. A film comprising the coating material composition according to claim 10.

15. A coated article comprising:
a substrate; and
the film according to claim 14 provided on the substrate.
